(19) United States
(12) Patent Application Publication
(10) Pub. No.: US 2025/0261087 A1
(43) Pub. Date: Aug. 14, 2025

(54) MIB MODIFICATION PERIOD

(71) Applicant: QUALCOMM Incorporated, San Diego, CA (US)

(72) Inventors: Ahmed BEDEWY, Hillsborough, NJ (US); Navid ABEDINI, Basking Ridge, NJ (US); Yongle WU, San Diego, CA (US); Yan ZHOU, San Diego, CA (US)

(21) Appl. No.: 18/440,214

(22) Filed: Feb. 13, 2024

(51) Int. Cl. H04W 48/10; H04W 52/02

(52) U.S. Cl. CPC H04W 48/10; H04W 52/0235

(57) ABSTRACT

A user equipment (UE) may transmit an UL-WUS to a network entity based on a predefined uplink wakeup signal (UL-WUS) parameter and one or more additional UL WUS parameters. The UE may obtain the at least one predefined UL-WUS parameter from a pre-configuration, signaling from a network entity, or both. The UE may receive the additional UL-WUS parameters via broadcast signaling from a network entity. The broadcast signaling may include a master information block (MIB), and may indicate the additional UL-WUS parameters via a set of bits. The UE may also receive an indication of a modification scheme associated with content changes of the broadcast signaling, an indication of a content change in the broadcast signaling, or both. The UE may process one or more subsequent broadcast signals based on the indication of the change, the indicated modification scheme, or both.

### FIELD OF TECHNOLOGY

The following relates to wireless communication, including a master information block modification period.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support a master information block (MIB) modification period. For example, the described techniques enable a UE to transmit an uplink wakeup signal (UL-WUS) to a network entity (e.g., in a network energy savings (NES) mode) based on obtaining one or more fixed (e.g., static, configured, defined, preconfigured) UL-WUS parameters. The UE may receive at least one additional UL-WUS parameter (e.g., for a UL-WUS configuration) via broadcast signaling (e.g., MIB signaling) and may process subsequent broadcast signals according to a MIB modification scheme associated with the UL-WUS configuration indicated by the broadcast signaling. In some cases, the at least one additional UL-WUS parameter may be separate from (e.g., configured separately from) parameters associated with random access channel (RACH) occasions (ROs).

In some examples, a content of the broadcast signaling may change periodically or aperiodically. The UE may receive an indication of a MIB modification scheme associated with the content changes of the broadcast signaling, where the MIB modification scheme may include a periodicity for changes, a rule for when the changes of the broadcast signaling may occur, a group of cells for which the modification scheme is common, a group of resources (e.g., frequency resources, time resources) for which the modification scheme is common, or any combination thereof. The UE may process one or more subsequent broadcast signals based on the indication of the change, the indicated MIB modification scheme, or both.

A method for wireless communication by a UE is described. The method may include obtaining one or more fixed parameters associated with a configuration for an UL-WUS associated with the UE, receiving, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more random access occasions associated with a random access procedure, and transmitting the UL-WUS during a wakeup signal occasion of the one or more wakeup signal occasions based on the one or more fixed parameters and on the at least one additional parameter.

A UE for wireless communication is described. The UE may include at least one processor, and at least one memory coupled with the at least one processor, with instructions stored in the at least one memory. The instructions may be executable by the at least one processor, individually or in any combination, to cause the apparatus (e.g., the UE) to obtain one or more fixed parameters associated with a configuration for an UL-WUS associated with the UE, receive, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more random access occasions associated with a random access procedure, and transmit the UL-WUS during a wakeup signal occasion of the one or more wakeup signal occasions based on the one or more fixed parameters and on the at least one additional parameter.

Another UE for wireless communication is described. The UE may include means for obtaining one or more fixed parameters associated with a configuration for an UL-WUS associated with the UE, means for receiving, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more random access occasions associated with a random access procedure, and means for transmitting the UL-WUS during a wakeup signal occasion of the one or more wakeup signal occasions based on the one or more fixed parameters and on the at least one additional parameter.

A non-transitory computer-readable medium storing code for wireless communication is described. The code may include instructions executable by one or more processors to obtain one or more fixed parameters associated with a configuration for an UL-WUS associated with the UE, receive, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more random access occasions associated with a random access procedure, and transmit the UL-WUS during a wakeup signal occasion of the one or more wakeup signal occasions based on the one or more fixed parameters and on the at least one additional parameter.

Some examples of the method, UEs, and non-transitory computer-readable medium described herein may further include operations, features, means, or instructions for obtaining an indication of a modification scheme associated with a content change for at least a portion of the broadcast signal and processing one or more subsequent broadcast signals based on the modification scheme.

In some examples of the method, UEs, and non-transitory computer-readable medium described herein, the modification scheme indicates a modification periodicity of an initial content change boundary.

In some examples of the method, UEs, and non-transitory computer-readable medium described herein, processing the one or more subsequent broadcast signals based on the modification scheme may include operations, features, means, or instructions for processing the one or more subsequent broadcast signals after an initial content change boundary that occurs after transmission of the UL-WUS.

In some examples of the method, UEs, and non-transitory computer-readable medium described herein, processing the one or more subsequent broadcast signals based on the modification scheme may include operations, features, means, or instructions for processing the one or more subsequent broadcast signals before an initial content change boundary, where the initial content change boundary may be a temporally first initial content change boundary after transmission of the UL-WUS.

In some examples of the method, UEs, and non-transitory computer-readable medium described herein, the one or more subsequent broadcast signals includes a second broadcast signal that may be a temporally first broadcast signal broadcasted after transmission of the UL-WUS.

In some examples of the method, UEs, and non-transitory computer-readable medium described herein, obtaining the indication of the modification scheme may include operations, features, means, or instructions for receiving signaling indicating the modification scheme from the network entity, from a second network entity, or both.

In some examples of the method, UEs, and non-transitory computer-readable medium described herein, obtaining the indication of the modification scheme may include operations, features, means, or instructions for receiving an RRC message or a SIB indicating the modification scheme.

In some examples of the method, UEs, and non-transitory computer-readable medium described herein, the modification scheme may be common for communications via a set of frequencies, for cells within a group, or both.

Some examples of the method, UEs, and non-transitory computer-readable medium described herein may further include operations, features, means, or instructions for establishing a link with the network entity based on transmitting the UL-WUS, receiving signaling indicating a content change in at least a portion of the broadcast signal, and processing one or more subsequent broadcast signals based on the signaling indicating the content change.

In some examples of the method, UEs, and non-transitory computer-readable medium described herein, receiving the signaling indicating the content change may include operations, features, means, or instructions for receiving information associated with one or more versions of the broadcast signal.

In some examples of the method, UEs, and non-transitory computer-readable medium described herein, processing the one or more subsequent broadcast signals may include operations, features, means, or instructions for configuring one or more receive beam parameters based on determining whether a correlation between a subsequent broadcast signal of the one or more subsequent broadcast signals and a version of the one or more versions of the broadcast signal satisfies a correlation threshold.

Some examples of the method, UEs, and non-transitory computer-readable medium described herein may further include operations, features, means, or instructions for determining the correlation threshold from a set of one or more correlation thresholds.

In some examples of the method, UEs, and non-transitory computer-readable medium described herein, receiving the signaling indicating the content change may include operations, features, means, or instructions for receiving a physical downlink control channel (PDCCH) transmission or a physical downlink shared channel (PDSCH) transmission indicating the content change in at least the portion of the broadcast signal based on establishing the link with the network entity.

Some examples of the method, UEs, and non-transitory computer-readable medium described herein may further include operations, features, means, or instructions for transmitting a request for information associated with a modification scheme for at least a portion of the broadcast signal, a request for information associated with a content change in at least the portion of the broadcast signal, or both.

In some examples of the method, UEs, and non-transitory computer-readable medium described herein, the broadcast signal includes a bitmap that indicates the at least one additional parameter and the at least one additional parameter indicates a preamble type, a sequence length, a transmission time, or any combination thereof, associated with the UL-WUS.

In some examples of the method, UEs, and non-transitory computer-readable medium described herein, the one or more fixed parameters include a preamble associated with the UL-WUS, a quantity of synchronization signal blocks per wakeup signal occasion, a root sequence index associated with the UL-WUS, a subcarrier spacing associated with the UL-WUS, a frequency division multiplexing parameter associated with the UL-WUS, a frequency domain location associated with the UL-WUS, a target power level associated with the UL-WUS, a threshold quantity of transmission attempts of the UL-WUS, or any combination thereof.

In some examples of the method, UEs, and non-transitory computer-readable medium described herein, obtaining the one or more fixed parameters may include operations, features, means, or instructions for receiving control signaling indicating the one or more fixed parameters.

A method for wireless communication by a network entity is described. The method may include outputting a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more random access occasions associated with a random access procedure and obtaining, for a UE the UL-WUS during a wakeup signal occasion of the one or more wakeup signal occasions based on the one or more fixed parameters and on the at least one additional parameter.

A network entity for wireless communication is described. The network entity may include at least one processor, and at least one memory coupled with the at least one processor, with instructions stored in the at least one memory. The instructions may be executable by the at least one processor, individually or in any combination, to cause the apparatus (e.g., the network entity) to output a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more random access occasions associated with a random access procedure and obtain, for a UE the UL-WUS during a wakeup signal occasion of the one or more wakeup signal occasions based on the one or more fixed parameters and on the at least one additional parameter.

Another network entity for wireless communication is described. The network entity may include means for outputting a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more random access occasions associated with a random access procedure and means for obtaining, for a UE the UL-WUS during a wakeup signal occasion of the one or more wakeup signal occasions based on the one or more fixed parameters and on the at least one additional parameter.

A non-transitory computer-readable medium storing code for wireless communication is described. The code may include instructions executable by one or more processors to output a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more random access occasions associated with a random access procedure and obtain, for a UE the UL-WUS during a wakeup signal occasion of the one or more wakeup signal occasions based on the one or more fixed parameters and on the at least one additional parameter.

Some examples of the method, network entities, and non-transitory computer-readable medium described herein may further include operations, features, means, or instructions for outputting an indication of a modification scheme associated with a content change for at least a portion of the broadcast signal and outputting one or more subsequent broadcast signals based on the modification scheme.

In some examples of the method, network entities, and non-transitory computer-readable medium described herein, the modification scheme indicates a modification periodicity of an initial content change boundary.

In some examples of the method, network entities, and non-transitory computer-readable medium described herein, outputting the one or more subsequent broadcast signals based on the modification scheme may include operations, features, means, or instructions for performing a content change of at least a portion of the one or more subsequent broadcast signals after an initial content change boundary that occurs after the UL-WUS may be obtained.

In some examples of the method, network entities, and non-transitory computer-readable medium described herein, outputting the one or more subsequent broadcast signals based on the modification scheme may include operations, features, means, or instructions for performing a content change of at least a portion of the one or more subsequent broadcast signals before an initial content change boundary, where the initial content change boundary may be a temporally first initial content change boundary after the UL-WUS may be obtained.

In some examples of the method, network entities, and non-transitory computer-readable medium described herein, outputting the one or more subsequent broadcast signals based on the modification scheme may include operations, features, means, or instructions for performing a content change of at least a portion of a second broadcast signal that may be a temporally first broadcast signal broadcasted after the UL-WUS may be obtained.

In some examples of the method, network entities, and non-transitory computer-readable medium described herein, outputting the indication of the modification scheme may include operations, features, means, or instructions for outputting an RRC message or a SIB indicating the modification scheme.

In some examples of the method, network entities, and non-transitory computer-readable medium described herein, the modification scheme may be common for communications via a set of frequencies, for cells within a group, or both.

Some examples of the method, network entities, and non-transitory computer-readable medium described herein may further include operations, features, means, or instructions for establishing a link with the UE based on the UL-WUS, outputting signaling indicating a content change in at least a portion of the broadcast signal, and outputting one or more subsequent broadcast signals based on the content change.

In some examples of the method, network entities, and non-transitory computer-readable medium described herein, outputting the signaling indicating the content change may include operations, features, means, or instructions for outputting information associated with one or more versions of the broadcast signal.

Some examples of the method, network entities, and non-transitory computer-readable medium described herein may further include operations, features, means, or instructions for outputting control signaling indicating a correlation threshold associated with the one or more subsequent broadcast signals and the one or more versions of the broadcast signal.

In some examples of the method, network entities, and non-transitory computer-readable medium described herein, outputting the signaling indicating the content change may include operations, features, means, or instructions for outputting a PDCCH transmission or a PDSCH transmission indicating the content change in at least the portion of the broadcast signal based on establishing the link with the UE.

Some examples of the method, network entities, and non-transitory computer-readable medium described herein may further include operations, features, means, or instructions for obtaining a request for information associated with a modification scheme for at least a portion of the broadcast signal, a request for information associated with a content change in at least the portion of the broadcast signal, or both.

In some examples of the method, network entities, and non-transitory computer-readable medium described herein, the broadcast signal includes a bitmap that indicates the at least one additional parameter and the at least one additional parameter indicates a preamble type, a sequence length, a transmission time, or any combination thereof, associated with the UL-WUS.

In some examples of the method, network entities, and non-transitory computer-readable medium described herein, the one or more fixed parameters include a preamble associated with the UL-WUS, a quantity of synchronization signal blocks per wakeup signal occasion, a root sequence index associated with the UL-WUS, a subcarrier spacing associated with the UL-WUS, a frequency division multiplexing parameter associated with the UL-WUS, a frequency domain location associated with the UL-WUS, a target power level associated with the UL-WUS, a threshold quantity of transmission attempts of the UL-WUS, or any combination thereof.

Some examples of the method, network entities, and non-transitory computer-readable medium described herein may further include operations, features, means, or instructions for outputting, to the UE, the one or more fixed parameters.

### BRIEF DESCRIPTION OF THE DRAWINGS

FIG. 1 shows an example of a wireless communications system that supports a master information block (MIB) modification period in accordance with one or more aspects of the present disclosure.

FIG. 2 shows an example of a wireless communications system that supports a MIB modification period in accordance with one or more aspects of the present disclosure.

FIG. 3 shows examples of signal timing diagrams that supports a MIB modification period in accordance with one or more aspects of the present disclosure.

FIG. 4 shows an example of a process flow that supports a MIB modification period in accordance with one or more aspects of the present disclosure.

FIGS. 5 and 6 show block diagrams of devices that support a MIB modification period in accordance with one or more aspects of the present disclosure.

FIG. 7 shows a block diagram of a communications manager that supports a MIB modification period in accordance with one or more aspects of the present disclosure.

FIG. 8 shows a diagram of a system including a device that supports a MIB modification period in accordance with one or more aspects of the present disclosure.

FIGS. 9 and 10 show block diagrams of devices that support a MIB modification period in accordance with one or more aspects of the present disclosure.

FIG. 11 shows a block diagram of a communications manager that supports a MIB modification period in accordance with one or more aspects of the present disclosure.

FIG. 12 shows a diagram of a system including a device that supports a MIB modification period in accordance with one or more aspects of the present disclosure.

FIGS. 13 and 14 show flowcharts illustrating methods that support a MIB modification period in accordance with one or more aspects of the present disclosure.

### DETAILED DESCRIPTION

In some wireless communications system, user equipments (UEs) (e.g., idle UEs, inactive UEs, connected UEs) may periodically receive broadcast signaling (e.g., a master information block (MIB), a system information block 1 (SIB1) message, remaining minimum system information (RMSI) message) from a network entity indicating information for establishing a connection with the network entity. When a network entity enters a network energy saving (NES) mode, it may refrain from sending the broadcast signaling to reduce energy usage. In some cases, another network entity (e.g., an anchor network entity, a network entity that provides coverage to a neighboring cell) may send the broadcast signaling instead of the NES mode network entity. Additionally, or alternatively, the NES mode network entity may transmit the broadcast signaling in response to (e.g., only in response to) receiving a request from a UE while in the NES mode.

As an example, the other network entity may configure some UEs with an uplink wakeup signal (UL-WUS) configuration for transmitting UL-WUSs, which may request the NES mode network entity to transmit (e.g., broadcast) the broadcast signaling. In some examples, if the UE does not receive the UL-WUS configuration, the UE may not be capable of requesting the broadcast signaling, which may increase latency associated with initial connection for the UE. In some cases, fixing the UL-WUS configuration for all cells (e.g., according to a set of standards) may limit the UL-WUS configuration, such that the UL-WUS configuration may not be cell-specific, leading to possible inter-cell interference. However, indicating an entire UL-WUS configuration over the air increases the amount of wireless resources used by the network and thus increasing overhead. In some cases, integrating an UL-WUS configuration into control signaling (e.g., broadcast signaling, existing control signaling) may be useful, however, the integration may interrupt UE behavior with the control signaling. Thus, low-resource-cost over the air communication techniques for a flexible UL-WUS configuration that can be integrated into control signaling may be beneficial.

According to the present disclosure, a UE may transmit an UL-WUS to a network entity (e.g., in an NES mode) based on obtaining one or more fixed (e.g., static, configured, defined, predetermined, preconfigured) UL-WUS parameters and receiving at least one additional UL-WUS parameter via broadcast signaling (e.g., MIB signaling) from a network entity. The UE may process subsequent broadcast signals according to a MIB modification scheme associated with indicating the UL-WUS configuration in the broadcast signaling. In some cases, the one or more additional UL-WUS parameters may be separate from (e.g., configured separately from) parameters associated with random access channel (RACH) occasions (ROs). Additionally, the broadcast signaling (e.g., a MIB) may indicate the at least one additional UL-WUS parameters via a set of bits (e.g., a bitmap, 8 bits, a field of bits) due to the one or more fixed UL-WUS parameters being excluded from (e.g., not indicated in) the broadcast signaling. In some cases, the UE may obtain the one or more fixed UL-WUS parameters from a preconfiguration (e.g., a standardized UL-WUS parameter set), from signaling from a network entity, or both.

In some cases, a content of the broadcast signaling may change (e.g., a portion of the content, including or excluding the UL-WUS configuration, may change) periodically or aperiodically. The UE may receive an indication of a MIB modification scheme associated with the content changes of the broadcast signaling, where the MIB modification scheme may include a periodicity for changes, a rule for when the changes of the broadcast signaling may occur, a group of cells for which the modification scheme is common, a group of resources (e.g., frequency resources, time resources) for which the modification scheme is common, or any combination thereof. Additionally, or alternatively, a UE (e.g., a connected UE) may receive an indication of a content change in the broadcast signaling. The UE (e.g., inactive, idle, or connected) may process one or more subsequent broadcast signals based on the indication of the change, the indicated MIB modification scheme, or both.

Aspects of the disclosure are initially described in the context of wireless communications systems. Aspects of the disclosure are also described in the context of signal timing diagrams and process flows. Aspects of the disclosure are further illustrated by and described with reference to apparatus diagrams, system diagrams, and flowcharts that relate to a MIB modification period.

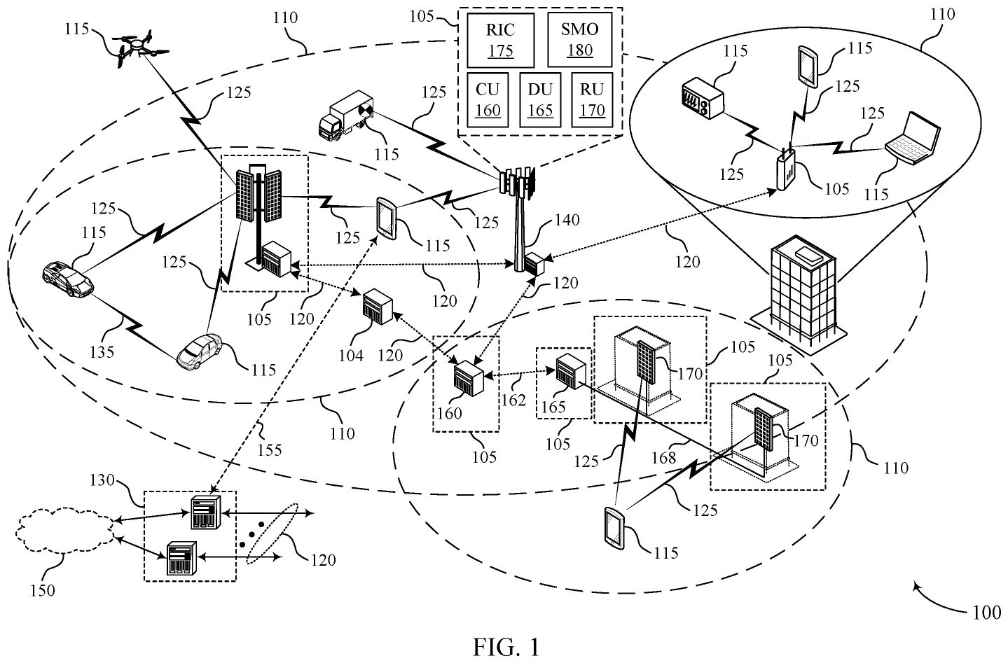

FIG. 1 shows an example of a wireless communications system 100 that supports a MIB modification period in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information (SI)), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

Additionally, or alternatively, one or more network entities 105 may employ operating modes that may reduce power consumption, which may be similar or different to the modes described herein with respect to UEs 115. In some cases, a mode of reducing power consumption at a network entity 105 may be called a NES mode. As used herein, NES mode may refer to any low power mode employed by a network entity 105. In some cases, the low power modes may be associated with limited signaling to and from the network entity 105, including limited uplink signaling, downlink signaling, backhaul signaling, and broadcast or multicast signaling.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In wireless communications system 100, UEs 115 may periodically receive broadcast signaling (e.g., SIB1, RMSI) from a network entity 105 indicating information for connecting with the network entity 105. When a network entity 105 enters an NES mode, it may refrain from broadcasting the broadcast signaling to reduce energy usage. In some cases, another network entity (e.g., an anchor network entity, a network entity that provides coverage to a neighboring cell) may broadcast the broadcast signaling instead of the network entity 105 operating in NES mode. Additionally, or alternatively, the network entity 105 operating in NES mode may transmit the signaling in response to (e.g., only in response to) receiving a request from a UE 115 while in the NES mode. For example, the other network entity may configure some UEs 115 with an UL-WUS configuration for transmitting UL-WUSs, which may request the network entity operating in NES mode to transmit the broadcast signaling. In some examples, if the UE 115 does not receive the UL-WUS configuration, it may not be capable of requesting the broadcast signaling. In some cases, fixing the UL-WUS configuration for all cells (e.g., according to a set of standards) may limit the UL-WUS configuration, such that the UL-WUS configuration may not be cell-specific, leading to possible inter-cell interference. However, indicating an entire UL-WUS over the air increases the amount of wireless resources used by a network entity 105. In some cases, integrating an UL-WUS configuration into control signaling may be useful, however the integration may interrupt UE 115 behavior with the control signaling.

According to the present disclosure, a UE 115 may transmit an UL-WUS to a network entity 105 based on obtaining one or more fixed UL-WUS parameters and receiving at least one additional UL-WUS parameters via broadcast signaling (e.g., MIB signaling) from a network entity 105. The UE may process subsequent broadcast signals according to a MIB modification scheme associated with indicating the UL-WUS configuration in the broadcast signaling. In some cases, the one or more additional UL-WUS parameters may be separate from (e.g., configured separately from) parameters associated with ROs. Additionally, the broadcast signaling (e.g., a MIB) may indicate the at least one additional UL-WUS parameters via a set of bits (e.g., a bitmap, 8 bits, a field of bits) due to the one or more fixed UL-WUS parameters being excluded from (e.g., not indicated in) the broadcast signaling. In some cases, the UE 115 may obtain the one or more fixed UL-WUS parameters from a preconfiguration (e.g., a standardized UL-WUS parameter), from signaling from a network entity 105, or both.

In some cases, a content of the broadcast signaling may change (e.g., a portion of the content, including or excluding the UL-WUS configuration, may change) periodically or aperiodically. The UE 115 may receive an indication of a MIB modification scheme associated with the content changes of the broadcast signaling, where the MIB modification scheme may include a periodicity for changes, a rule for when the changes of the broadcast signaling may occur, a group of cells for which the modification scheme is common, a group of resources (e.g., frequencies, times) for which the modification scheme is common, or any combination thereof. Additionally, or alternatively, a UE 115 (e.g., a connected UE) may receive an indication of a content change in the broadcast signaling. The UE 115 may process one or more subsequent broadcast signals based on the indication of the change, the indicated MIB modification scheme, or both.

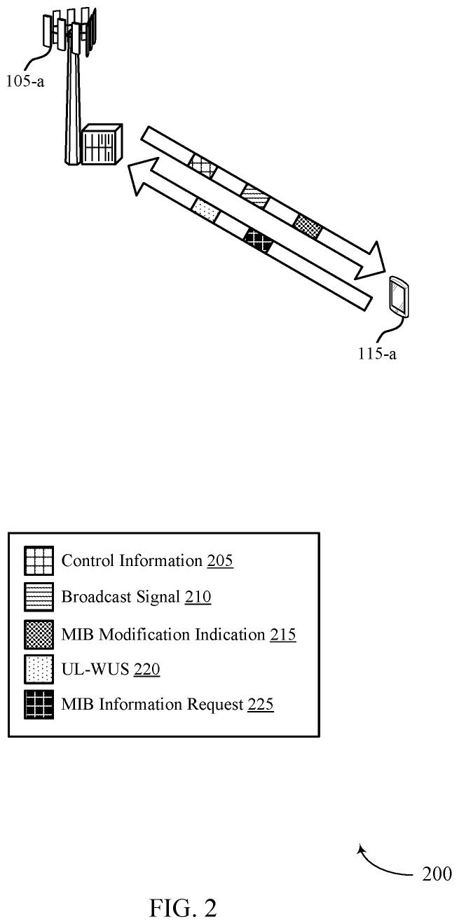

FIG. 2 shows an example of a wireless communications system 200 that supports a MIB modification period in accordance with one or more aspects of the present disclosure. In some cases, aspects of the wireless communications system 200 may implement or be implemented by aspects of FIG. 1. For example, the wireless communications system 200 may include a network entity 105-a and one or more UEs 115 (e.g., a UE 115-a), which may be examples of the network entities 105 and the UEs 115, respectively, as described herein with respect to FIG. 1. In some cases, the UE 115-a may transmit an UL-WUS 220 to the network entity 105-a based on one or more fixed UL-WUS configuration parameters and at least one additional UL-WUS configuration parameters indicated by the broadcast signal 210. Additionally, the UE 115-a may receive a MIB modification indication 215 based on, in some examples, transmitting a MIB information request 225.

As described herein, some wireless communications system may implement a NES mode (e.g., technique) for a network entity 105-a. In an NES mode, a network entity 105-a may refrain from broadcasting one or more broadcast signals. For example, the broadcast signals may include a SIB1, or an RMSI, which a UE 115-a in the wireless communications system 200 may use for initial connection purposes. In the NES mode, the network entity 105-a may transmit the broadcast signals in response to receiving a request for the broadcast signals from a UE 115-a. The request from the UE 115-a may be referred to as an UL-WUS.

In some cases, supporting direct access to the network entity 105-a with minimal (e.g., or no) assistance from another network entity (e.g., in a standalone manner) may be desirable. For example, the network entity 105-a may support a first technology (e.g., be a 6G cell), and the other network entity may support a second technology (e.g., be a 5G cell). In some cases, supporting access to the network entity 105-a without receiving information from a network entity of a different technology may be beneficial.

However, indicating a configuration for the UL-WUS associated with the network entity 105-a to UEs 115 (e.g., idle UEs, inactive UEs) may be a challenge without assistance from another network entity. For example, for an assisted access to the network entity 105-a, the other network entity may provide the UL-WUS configuration (e.g., in an SI element transmitted by the other network entity) to the UEs 115. However, for a non-assisted access to the network entity 105-a, preconfiguring or fixing the UL-WUS may be limiting for the network entities, such that each cell (e.g., covered by a different network entity), may be associated with the same configuration for UL-WUS, which may cause interference and disorder in the wireless communications system. According to techniques described herein, the network entity 105-a may broadcast at least a portion of the UL-WUS configuration via a broadcast signal, where the broadcast signal may be a PBCH transmission carrying a MIB.

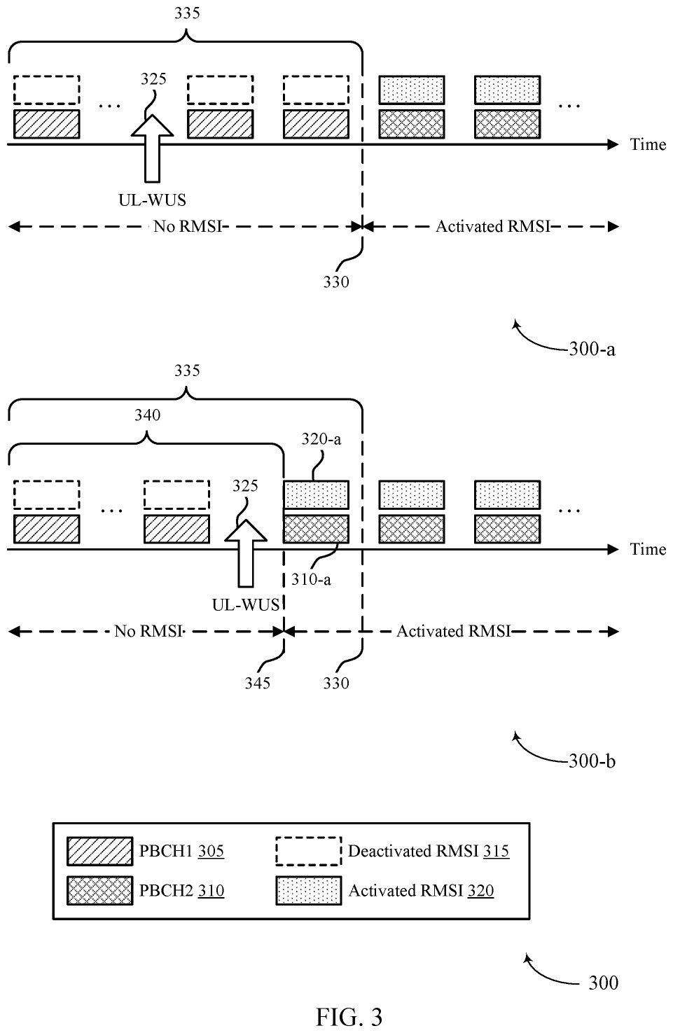

For example, in a non-assisted access situation, the MIB may indicate at least a portion of the UL-WUS configurations (e.g., the at least one additional parameter), where the network entity 105-a (e.g., an NES network entity) may broadcast the MIB periodically. After receiving the UL-WUS 220 from the UE 115-a, the network entity 105-a may transmit (e.g., broadcast) an RMSI along with a PBCH transmission that includes the MIB, and the MIB may then include one or more fields indicating a physical downlink control channel (PDCCH) configuration for RMSI (e.g., an RMSI configuration), where the RMSI configuration may assist the UEs 115-a (e.g., idle or inactive UEs) in decoding the RMSI (e.g., as described herein with respect to FIG. 3).

However, during periods where the network entity 105-a may not transmit RMSI (e.g., RMSI is deactivated, as described herein with respect to FIG. 3), the network entity 105-a may repurpose the one or more fields (e.g., bits in the one or more fields) of the MIB to indicate at least a portion of the UL-WUS configuration. Thus, during periods where the network entity 105-a transmits RMSI (e.g., where a UE 115 triggers RMSI from the network entity 105-a), the MIB may indicate an RMSI configuration, and during periods where the network entity 105-a may not transmit RMSI (e.g., where the UE 115 has not triggered RMSI from the network entity 105-a), the MIB may indicate at least a portion of an UL-WUS configuration.

In some cases, a MIB may include a set of bits (e.g., a bit map, 8 bits) which may indicate an RMSI configuration. For example, during a period where the network entity 105-a may not transmit an RMSI (e.g., a period for transmitting non-cell defining (CD) synchronization signal blocks (SSBs)), the network entity 105-a may repurpose the set of bits of the MIB (e.g., in the PBCH) to indicate one or more other resources (e.g., another synchronization raster) which may be transmitting CD-SSBs. In some cases, the UE 115-a may use the MIB to determine that a set of control resources (e.g., a CORESET for Type0-PDCCH common search space (CSS)) is not present in the broadcast signaling from the network entity 105-a. For example, if the MIB indicates that a resource offset parameter (e.g., k_SSB) is greater than a threshold value (e.g., 23 for frequency range 1 (FR1), 11 for frequency range 2 (FR2) (e.g., mmWave)), the UE 115-a may determine that the set of control resources is not present.

According to the techniques described herein, the set of bits of the MIB may indicate (e.g., instead of the synchronization raster) at least one additional parameter for an UL-WUS configuration based on one or more fixed parameter for UL-WUS configuration being excluded from (e.g., not defined in) the MIB (e.g., being defined elsewhere for the UE 115-a). In some cases, RACH procedures may share one or more occasions (e.g., resource sets for transmitting the UL-WUS, frequency and time resources, ROs) with UL-WUS configurations, such that ROs and UL-WUS occasions may overlap. However, when the occasions are not shared, the one or more fixed parameters for UL-WUS configuration may be fixed (e.g., a single value, unchanging, relatively low frequency of change), or limited to a range of values, such that the set of bits of the MIB may be sufficient to indicate the at least one additional parameters for the UL-WUS configuration. For example, the one or more fixed parameter may be fixed in one or more standards documents, or the fixed parameters may be transmitted to the UEs 115 via another (e.g., neighboring, anchor) network entity. Thus, the network entity 105-a may indicate an UL-WUS configuration in a standalone manner, and the indication may integrate well with broadcast signaling due to a low resource draw for indicating the UL-WUS configuration.

TABLE 1

| | Quantity of bits | |
|---|---|---|
| | Not shared | Shared |
| Parameter | with ROs | with ROs |
| rach-ConfigGeneric | <8 | 17 |
| totalNumberOfRA-Preambles | 0 | 0 |
| ssb-perRACH-OccasionAndCB-PreamblesPerSSB | 0 | 3 |
| groupBconfigured | 0 | 0 |
| ra-ContentionResolutionTimer | 0 | 0 |
| rsrp-ThresholdSSB | 0 | 0 |
| rsrp-ThresholdSSB-SUL | 0 | 0 |
| prach-RootSequenceIndex | 0 | 0 |
| msg1-SubcarrierSpacing | 0 | 3 |
| restrictedSetConfig | 0 | 0 |
| msg3-transformPrecoder | 0 | 0 |
| ra-PrioritizationForAccessIdentity-r16 | 0 | 0 |
| prach-RootSequenceIndex-r16 | 0 | 0 |
| ra-PrioritizationForSlicing-r17 | 0 | 0 |
| featureCombinationPreamblesList-r17 | 0 | 0 |

TABLE 2

| | Quantity of bits | |
|---|---|---|
| | Not shared | Shared |
| Parameter (e.g., within rach-ConfigGeneric) | with ROs | with ROs |
| prach-ConfigurationIndex | <8 | 8 |
| msg1-FDM | 0 | 0 |
| msg1-FrequencyStart | 0 | 9 |
| zeroCorrelationZoneConfig | 0 | 0 |
| preambleReceivedTargetPower | 0 | 0 |
| preambleTransMax | 0 | 0 |
| powerRampingStep | 0 | 0 |
| ra-ResponseWindow | 0 | 0 |

As described herein, Table 1 and Table 2 may include examples of parameters (e.g., information elements (IEs)) used in some wireless communications systems for configuring RACH procedures. A configuration of UL-WUS may use similar parameters to a RACH configuration, and thus the wireless communications system 200 may use similar parameters to those of Tables 1 and 2 (e.g., but called a different name or title) for UL-WUS configuration. The Tables 1 and 2 may include a quantity of bits that the network entity 105-a may use for indicating the parameter to the UEs 115 if the respective parameter is not fixed (e.g., in a standards document, in the control information 205 from the network entity 105-a or another network entity). In some cases, a parameter of the Tables 1 and 2 may not be fixed in a scenario where ROs are shared with UL-WUS occasions, and thus the Tables 1 and 2 may indicate a quantity of bits for indicating each parameter according to whether ROs are shared with UL-WUS occasions in the wireless communications system 200.

In some cases, the Tables 1 and 2 may not include one or more other parameters (e.g., IEs). For example, a time duplexing parameter (e.g., “TDD config”) and an SSB listing parameter (e.g., “list of transmitted SSBs”) may be limited or removed from the configuration of UL-WUS 220, even though these parameters may assist in validating UL-WUS occasions. In some cases, the limiting or removing of the parameters may not affect a performance of the wireless communications system 200 due to, for example, the network entity 105-a ensuring that indicated UL-WUS occasions (e.g., indicated by the UL-WUS configuration in the at least one predetermined parameter and the one or more additional parameters) do not collide with downlink or SSB symbols (e.g., of other cells, of the cell covered by the network entity 105-a), or due to the network entity 105-a supporting a full-duplex (e.g., dynamic) TDD scheme.

For example, the techniques described herein may be associated with low-load (e.g., low wireless communication traffic load) scenarios, such that even if the UL-WUS occasions may collide with downlink symbols, the network entity 105-a (e.g., an NES cell) may avoid scheduling downlink transmission on the colliding downlink symbols. Stated differently, limiting or removing the parameters (e.g., the parameter “TDD config” and “list of transmitted SSBs”) may not affect the performance of the wireless communications system 200 because, in a full duplex (e.g., concurrent uplink and downlink transmissions) scenario, the network entity 105-a may receive the UL-WUS while transmitting downlink signaling, and, in a half-duplex (e.g., non-overlapping uplink and downlink transmissions) scenario, the network entity 105-a may ensure that there are not collisions between the UL-WUS and downlink transmissions.

In some cases, the Table 2 may be a further definition of parameters within the parameter “rach-ConfigGeneric” of Table 1.

In addition to the parameters of Tables 1 and 2, the UEs 115 may receive a preconfiguration of a resource offset parameter (e.g., k_SSB may be fixed). In some cases, a UE 115 (e.g., an idle UE, an inactive UE) may not be initially configured with an accurate value of the resource offset parameter, and thus may not be able to determine a resource set (e.g., an RB grid for the network entity 105-a) for transmitting the UL-WUS 220 to the network entity 105-a. Thus, according to techniques described herein, the UE 115 may receive a preconfiguration of the resource offset parameter for the purpose of determining the resources used for transmitting the UL-WUS 220.

In some cases, one or more parameters listed in Tables 1 and 2 may be more valuable for an UL-WUS configuration than others of the listed parameters (e.g., which may not be needed for UL-WUS configuration). For example, parameters such as groupBconfigured, ra-ContentionResolutionTimer, rsrp-ThresholdSSB-SUL, restrictedSetConfig, msg3-transformPrecoder, ra-PrioritizationForAccessldentity-r16, prach-RootSequencelndex-r16, ra-PrioritizationForSlicing-r17, and featureCombinationPreamblesList-r17 of Table 1 may not be valuable (e.g., may not be needed) for an UL-WUS configuration, and thus may not be fixed in standards documents or signaled in control information 205 or the broadcast signal 210 for an UL-WUS configuration. Additionally, or alternatively, parameters such as powerRampingStep and ra-ResponseWindow, from the Table 2, may not be valuable for an UL-WUS configuration, and thus may not be fixed in standards documents or signaled in control information 205 or the broadcast signal 210 for an UL-WUS configuration.

In some cases, one or more of the parameters of Tables 1 and 2 may be valuable for an UL-WUS configuration. For example, a parameter such as the totalNumberOfRA-Preambles may indicate a preamble for a UE 115 to use when transmitting the UL-WUS 220; a parameter such as ssb-perRACH-OccasionAndCB-PreamblesPerSSB may indicate a quantity of synchronization signal blocks associated with each UL-WUS occasion, and may be fixed to a single value (e.g., or a choice between 8 values if RO occasions are shared with UL-WUS occasions), and the “CB-PreamblesPerSSB” portion may be irrelevant to UL-WUS configuration; a parameter such as rsrp-ThresholdSSB may not be valuable to an UL-WUS configuration because the network entity 105-a may be in an NES mode and thus not associated with high traffic or contention; a parameter such as prach-RootSequenceIndex may indicate a fixed root sequence index associated with the UL-WUS 220, where the network entity 105-a may orthogonalize different UL-WUSs 220 for different network entities 105 in a time domain to avoid collisions of UL-WUSs 220 for neighboring cells; a parameter such as msg1-SubcarrieSpacing may indicate a subcarrier spacing associated with the UL-WUS 220, and may be fixed to a single value (e.g., or a choice of 8 values (e.g., using 3 bits) if ROs are shared with UL-WUS occasions); a parameter such as msg1-FDM may be a frequency division multiplexing parameter associated with the UL-WUS 220, and may indicate a quantity of UL-WUS occasions that have been FDMed into one time resource, and may be fixed to a single value (e.g., 1) for UL-WUS 220; a parameter such as msg1-FrequencyStart may indicate a frequency domain location (e.g., a starting location) associated with the UL-WUS 220 (e.g., a preamble for the UL-WUS 220) and may be fixed to a single value (e.g., or indicated via 9 bits if ROs are shared with UL-WUS occasions); a parameter such as zeroCorrelationZoneConfig may indicate a threshold distance between UE 115-a and another UE 115 (e.g., UEs 115 in the cell that the network entity 105-a covers), and may be fixed to a single value; a parameter such as preambleReceivedTargetPower may indicate a target power level associated with the UL-WUS 220, which may be fixed to a single value (e.g., the UEs 115 may blast the UL-WUS 220, or use maximum power available, due to a lack of contention) or indicated via 8 bits (e.g., if ROs are shared with UL-WUS occasions); and a parameter such as preambleTransMax may indicate a threshold quantity of transmission attempts of the UL-WUS 220, and may be fixed to a single value or left as no threshold (e.g., no limit). In some cases, one or more of these parameters may be included in the one or more fixed parameters for the UL-WUS configuration, which may be fixed in a standards document, indicated to the UEs 115 via the control information 205 (e.g., from the network entity 105-a or another network entity), or any combination thereof.

In some cases, a parameter such as prach-ConfigurationIndex (e.g., of Table 2) may indicate one or more configurations for the UL-WUS 220. For example, a parameter such as prach-ConfigurationIndex may indicate resources for the UL-WUS 220, including a preamble type, a sequence length, a transmission time, or any combination thereof, associated with the UL-WUS 220. In some cases, a parameter such as prach-ConfiurationIndex (e.g., but for UL-WUS configuration) may be indicated via the set of bits (e.g., 8 bits, a bitmap) in the MIB of the broadcast signal 210, and may be indicated via less than 8 bits (e.g., a reduced set) if ROs are not shared with UL-WUS occasions. Stated differently, a parameter such as prach-ConfigurationIndex may represent the flexible portion of the configuration for the UL-WUS 220, and may be the at least one additional UL-WUS configuration parameter.

Thus, according to the techniques described herein, the UE 115-a may obtain one or more fixed parameters associated with UL-WUS configuration (e.g., via preconfiguration according to one or more standards documents, via control information 205 from the network entity 105-a or another network entity) and may receive at least one additional parameter associated with UL-WUS configuration via broadcast signaling (e.g., via a field of bits in a MIB of the broadcast signal 210). The UE 115-a may transmit the UL-WUS 220 to the network entity 105-a based on the one or more fixed parameter and the at least one additional parameters.

The wireless communications system 200 may also include a MIB modification indication 215, which may indicate information associated with a content change of the MIB of the broadcast signal 210 (e.g., or other instances of the broadcast signal 210). The information may indicate a MIB modification scheme for the content of the MIB (e.g., the set of bits in the MIB), an indication that at least a portion (e.g., the set of bits) of the MIB has changed (e.g., or will change), or an indication of (e.g., a description of, information associated with) one or more versions (e.g., hypotheses) of the broadcast signal 210, which may each include different contents in at least the portion of the MIB. The wireless communications system 200 may also include a MIB information request 225, where the network entity 105-a may transmit the MIB modification indication 215 in response to receiving the MIB information request 225 from the UE 115-a. A more detailed description of the MIB modification indication 215 and the MIB information request 225 may be found in the description of FIG. 3.

FIG. 3 shows examples of signal timing diagrams 300 (e.g., a signal timing diagram 300-a, a signal timing diagram 300-b) that support a MIB modification period in accordance with one or more aspects of the present disclosure. In some cases, aspects of the signal timing diagrams 300 may implement or be implemented by aspects of FIGS. 1 and 2. For example, the signal timing diagrams 300 may include PBCHs (e.g., PBCHs 1 305, PBCHs 2 310) and RMSIs (e.g., deactivated RMSIs 315, activated RMSIs 320), which may be transmitted by network entities 105 and received by UEs 115, as described herein with respect to FIGS. 1 and 2. In some cases, the PBCHs of the signal timing diagrams 300 may include or be examples of the broadcast signal 210 of FIG. 2. Additionally, the signal timing diagrams may include an UL-WUS (e.g., such as UL-WUS 220 of FIG. 2) which may be transmitted by a UE 115 to a network entity 105, as described herein with respect to FIGS. 1 and 2. In some cases, the signal timing diagram 300-a may show transmission timing for one or more signals according to a first (e.g., exemplary) MIB modification scheme, and the signal timing diagram 300-b may show transmission timing for one or more signals according to a second (e.g., exemplary) MIB modification scheme.

In some cases (e.g., during a cell selection procedure), a UE (e.g., a UE 115 as described herein, an idle UE, a connected UE) may process (e.g., combine) one or more PBCHs (e.g., instances of a PBCH, PBCH1 305, PBCH2 310) to enhance reception quality of the PBCHs, where the processing may benefit from the one or more PBCHs having identical content. For example, the UE may rely (e.g., at least in part) on combining multiple PBCHs to achieve successful decoding of the PBCHs, and thus connect with a network entity (e.g., a network entity 105 as described herein). Thus, if a content of the PBCHs varies over time, the UE may suffer from poor decoding accuracy (e.g., poor combining results) of the PBCHs.

In some cases, the network entity may guarantee a level of combining (e.g., a quantity of identical PBCHs to be combined) by guaranteeing an unchanged content of the MIB in the PBCHs for a time period (e.g., a quantity of millisecond). For example, after receiving an UL-WUS 325, the network entity may maintain a MIB content in the PBCH constant for a period of time to allow a UE to perform a level of combining.

In some wireless communications systems, a UE may perform multiple steps for combining PBCHs to counteract the negative effects of possibly changing MIB content in a PBCH. For example, the UE (e.g., with no prior configuration to determine PBCH content changes) may assume that the MIB content will change while combining multiple instances of the PBCH over time. For example, MIB may carry a quantity of most significant bits (MSBs) (e.g., 6 MSBs) of an SFN, and thus a content of the MIB may change according to a regular period (e.g., 160 msec). Assuming that the UE receives PBCHs with a first MIB content until an initial content change boundary and then begins receiving PBCHs with a second MIB content after the initial content change boundary, the UE may, in a first cycle (e.g., of 20 msec), receive and decode a first PBCH. Then, in a second cycle, the UE may receive a second PBCH, and the UE may decode the second PBCH as well as decode a combination of the first and second PBCHs (e.g., without determining if a MIB content of each PBCH is the same). In a third cycle, the UE may receive a third PBCH, and the UE may decode the third PBCH, a combination of the third and second PBCH, and a combination of the third, second, and first PBCH. The UE may continue a similar process (e.g., receiving another PBCH and decoding the PBCH along with each combination of previously received PBCHs) for a quantity of cycles (e.g., 4 cycles). In this way, if the initial content change boundary occurs between two of the cycles (e.g., or does not), the UE may be guaranteed to have received and decoded at least 2 pairs of identical PBCHs, or 3 identical PBCHs (e.g., which may assist in decoding the PBCH).

According to techniques described herein, and as illustrated by the signal timing diagram 300-a, a UE (e.g., a UE 115 as described herein) may communicate PBCHs and RMSIs according to a first (e.g., exemplary) MIB modification scheme. The first MIB modification scheme may include aligning a MIB modification period with an initial content change boundary 330. In some cases, the initial content change boundary 330 may be a beginning of a period associated with a next subframe number, and (e.g., according to the first MIB modification scheme) a network entity may perform a MIB content change (e.g., adjust the content of the set of bits in the MIB) at the initial content change boundary. In some cases, the initial content change boundary may occur periodically (e.g., with a period of 160 msec).

As an example of implementing the first MIB modification scheme, a network entity may transmit PBCH1s 305 during a period 335, where the period 335 may end at the initial content change boundary 330. In some cases, the PBCH1s 305 may be a version of the PBCH that does not indicate information to assist the UE in decoding activated RMSIs 320 (e.g., or SIB1s), and thus the network entity may not transmit RMSIs during the period 335 (e.g., the period 335 may include deactivated RMSIs 315). For example, the set of bits of the MIB of the PBCH1s 305 may indicate the one or more additional parameters for UL-WUS configuration during the period 335 instead of the RMSI configuration (e.g., as described herein with respect to FIG. 2). During the period 335, the UE may transmit an UL-WUS to the network entity based on the one or more fixed parameters (e.g., as described herein with respect to FIG. 2) and at least one additional parameters for UL-WUS configuration from the MIB of the PBCHs1 305. Then, according to the first MIB modification scheme, the network entity may refrain from transmitting activated RMSIs 320 and performing a MIB content change (e.g., changing the 6 MSB of the SFN and the IEs related to the indicated RMSI configuration) in response to the UL-WUS 325 until after the initial content change boundary 330. Thus, the UE may process the PBCH2s 310 and the activated RMSIs 320 (e.g., one or more subsequent broadcast signals) after the initial content change boundary 330.

In some cases, a wireless communications system (e.g., the wireless communications system 200 as described herein) implementing the first MIB modification scheme may flexibly indicate the at least one additional parameter for UL-WUS configuration in the set of bits of the MIB of the PBCH1s in a manner that easily integrates into existing procedures between the network entity and one or more UEs. For example, another UE may continue performing PBCH combining as described herein, where the initial content change boundary 330 may occur in between two cycles. Additionally, a UE implementing the first MIB modification scheme may refrain from processing the PBCH2s 310 (e.g., and the activated RMSIs 320) until after the initial content change boundary 330 (e.g., when the MIB content changes).

As illustrated by the signal timing diagram 300-b, a UE (e.g., a UE 115 as described herein) may communicate PBCHs and RMSIs according to a second (e.g., exemplary) MIB modification scheme. The second MIB modification scheme may include a network entity performing flexible MIB content modification which may not be aligned with the initial content change boundary 330. For example, the network entity may perform a MIB content change directly in response to (e.g., directly after) receiving an UL-WUS 325 from the UE.

As an example of implementing the second MIB modification scheme, a network entity may transmit PBCHls 305 during at least a portion 340 of the period 335, where the period 335 may end at the initial content change boundary 330. As described herein, the PBCHls may be associated with MIB content that indicates the at least one additional parameter for UL-WUS configuration, and thus the portion 340 may include deactivated RMSIs 315 (e.g., the network entity may not transmit RMSIs during the portion 340 due to being in an NES mode). The network entity may receive (e.g., during the period 335) an UL-WUS 325 from a UE. In response to receiving the UL-WUS 325, the network entity may, at 345 (e.g., immediately after receiving the UL-WUS 325, at a next available PBCH cycle), perform a partial content change of the MIB such that a temporally next (e.g., subsequent to the UL-WUS 325) PBCH may be a PBCH2 310-a, which may include an indication of the RMSI configuration in the MIB. The network entity may broadcast the PBCH2 310-a before the initial content change boundary 330. Additionally, at 345, the network entity may begin transmitting activated RMSIs 320.

The partial content change of the MIB may include altering the set of bits (e.g., IEs related to RMSI PDCCH config) from indicating the one or more additional parameter for UL-WUS configuration (e.g., such as in PBCH1 305) to indicating an RMSI configuration (e.g., as in PBCH2 310). In some cases, the network entity may transmit one or more PBCH2s 310 (e.g., at a regular periodicity) between the partial content change at 345 and the initial content change boundary 330. At the initial content change boundary 330, the network entity may perform an additional content change to one or more other portions of the PBCH2s 310 (e.g., portions other than the set of bits of the MIB, the 6 MSB of the SFN). Thus, the UE may process the PBCH2s 310 and the activated RMSIs 320 (e.g., one or more subsequent broadcast signals) before a temporally next initial content change boundary 330. Stated differently, the UE may process (e.g., combine) one or more subsequent broadcast signals (e.g., subsequent to the UL-WUS 325) including the PBCH2 310-a, an associated activated RMSI 320-a, or both, which may be broadcast signals that the network entity broadcasts temporally first (e.g., out of other subsequent broadcast signals) after receiving the UL-WUS 325.

In some cases, a network entity (e.g., the network entity 105 as described herein) implementing the second MIB modification scheme may transmit a requested activated RMSI 320 immediately (e.g., in a next possible RMSI period), reducing latency for a requesting UE. Additionally, another UE may continue performing PBCH combining as described herein. However, the other UE may be guaranteed to receive 2 identical PBCHs (e.g., instead of 3 identical PBCHs as described in other scenarios), since there are 3 content versions of the PBCH described in the second MIB modification scheme (e.g., PBCH1 305, PBCH2 310 with first set of MSBs of the SFN, and PBCH2 310 with second set of MSBs of the SFN). Thus, a UE implementing the second MIB modification scheme may process the PBCH2s 310 (e.g., and the activated RMSIs 320) before the initial content change boundary 330 (e.g., when the MIB content changes).

In order to implement either of the MIB modification schemes as described herein, a network entity and a UE (e.g., network entity 105 and UE 115 as described herein) may exchange signaling, including the MIB modification indication 215 of FIG. 2, associated with MIB modification. For example, the signaling may indicate a selection of a MIB modification scheme (e.g., between the first MIB modification scheme and the second MIB modification scheme) for the network entity to use. Additionally, or alternatively, the signaling may indicate a MIB modification period (e.g., such as the initial content change boundary 330 periodicity, as described for the first MIB modification scheme, or another periodicity for the MIB content change), which may align with the initial content change boundaries 330 (e.g., of 160 msec periodicity). In some cases, one or more standards documents may indicate a MIB modification scheme to implement. Additionally, or alternatively, another network entity (e.g., a neighboring cell) may transmit the signaling to the UE (e.g., in dedicated RRC signaling or SIB (e.g., SIB2-4)), or the network entity may transmit the signaling to the UE (e.g., in dedicated RRC signaling or SIB (e.g., SIB1)).

Additionally, or alternatively, a MIB modification scheme (e.g., of the first and second MIB modification schemes) may be common for a group of cells in a same raster or for a group of frequencies (e.g., bandwidths). For example, the UE may receive signaling indicating a group (e.g., of cells, of frequencies) and an associated MIB modification scheme, or MIB modification schemes may be assigned to corresponding groups via one or more standards documents.

In some cases, a UE may use multiple PBCHs (e.g., re-encoded PBCHs) for tracking and beam management (e.g., receive beam management) purposes. For example, a UE (e.g., a connected UE, an idle UE) may decode a first MIB of a first PBCH, then subsequently decode a second PBCH based on the first MIB, where the UE may determine one or more beam metrics for beam management based on decoding the second PBCH. However, if a content of the first MIB of the first PBCH is different from a content of a second MIB of the second PBCH, the decoding of the second PBCH may not be accurate, and thus may lead to inaccurate tracking or beam management. For example, according to the second MIB modification scheme described herein, a content of the MIB may change flexibly, and thus to effectively track or perform beam management based on the PBCHs (e.g., PBCH1s 305, PBCH2s 310), the UE may reacquire (e.g., decode) MIB frequently (e.g., in each PBCH cycle). However, this may add latency to the tracking and beam management procedure.

In some cases, tracking and beam management according to the PBCHs may be more effective in conjunction with the second MIB modification scheme described herein. For example, a UE may experience increased effectiveness in tracking and beam according to the PBCHs if the network entity increases the period 335 (e.g., a MIB modification period, according to the first MIB modification scheme, increasing to 640 msec), such that a content of a MIB is constant for longer periods. However, increasing a size of the period 335 may also cause the network entity to transmit the RMSI (e.g., SIB1) for longer periods while attempting to enter NES mode, which may reduce power savings. Thus, a method of integrating UL-WUS configuration in the MIB while maintaining effective tracking and beam management according to PBCHs may be desired.

According to techniques described herein, the network entity may provide information associated with the content of the MIB to UEs (e.g., connected UEs). For example, the network entity may indicate to the UEs whether a content of the MIB has changed. For example, the network entity may indicate a content change of the MIB before the content change (e.g., before the initial content change boundary 330 or before 345), concurrently with the content change (e.g., at the initial content change boundary 330 or at 345), or after the content change. In some cases, the MIB modification indication 215 of FIG. 2 may indicate the content change of the MIB to the UEs.

In some cases, and in order to save wireless communications resources (e.g., prevent the UEs from monitoring for the MIB content information), the MIB modification indication 215 may include or be included in one or more PDSCH transmissions, one or more PDCCH transmissions, or both, to indicate the content change in at least a portion of the MIB. In some cases, the network entity may transmit the one or more PDSCH transmissions or PDCCH transmissions to the UEs based on establishing a connection between the network entity and the UEs (e.g., based on the UL-WUS 325 and the activated RMSIs 320). In this way, the MIB modification indication 215 may be included in (e.g., piggyback) other indications transmitted to the UEs.

In some cases, based on the MIB modification indication 215, the UEs may determine a content change in the MIB, and thus the UEs may avoid decoding one or more following MIBs (e.g., even if there is no content change). Instead, according to techniques described herein, the UEs may perform one or more correlations between a received PBCH (e.g., with a content change in the corresponding MIB, after receiving the MIB modification indication 215) and one or more versions (e.g., encoded versions, hypotheses) of the PBCH. As described herein, the versions of the PBCH may include a version where the content of the MIB (e.g., the set of bits of the MIB) indicates an RMSI configuration, and a version where the content of the MIB indicates an UL-WUS configuration.

For example, in order to reduce decoding overhead at a UE, the UE may perform one or more correlations using one or more (e.g., two) versions of the PBCH once in each MIB modification period (e.g., 160 msec). In some cases, the PBCH version may be constant during the MIB modification period (e.g., according to the first MIB modification scheme), and thus the UE may determine the PBCH version of the MIB modification period and perform decoding of the PBCH (e.g., for tracking and beam management) based on the MIB content for the respective MIB modification period.

In some cases, the UE may determine (e.g., learn) a more probable version of the PBCH of the one or more versions of the PBCH for a period of time. For example, the UE may determine, based on analyzing past data, that a time of the day or night (e.g., 3 am) may be associated with deactivated RMSIs 315 (e.g., not associated with activated SIB1s, and thus associated with a version of the PBCH where the MIB content indicates an UL-WUS configuration). As an example, if few UEs demand RMSI transmissions at the time of the day or night on a regular basis, the time of the day or night may include many deactivated RMSIs 315 on a regular basis. Thus, at the time of the day or night, the UE may first perform a correlation with a received PBCH using (e.g., For example) the version of the PBCH indicating the UL-WUS configuration. In this manner, the UE may first perform a correlation between a received PBCH and a more probable version of the PBCH. Then, if a result of performing the correlation does not satisfy (e.g., is below) a correlation threshold, the UE may perform a second correlation between the receive PBCH and a second version of the PBCH. In a case where the PBCH may be associated with more than two versions, the UE may perform more correlations using more versions of the PBCH until a version of the PBCH has a correlation with the received PBCH that satisfies the correlation threshold.

The UE may obtain a value for the correlation threshold via one or more methods. For example, the UE may determine the value for the correlation threshold from a set of correlation value thresholds based on, for example, previous correlation data stored at the UE or at the network entity. Additionally, or alternatively, the UE may be preconfigured with the value for the correlation threshold based on one or more standards documents. Additionally, or alternatively, the value of the threshold may be signaled over the air (e.g., from the network entity, from another UE) to the UE.

In some cases, the UE may determine the version of the PBCH (e.g., hypotheses of the PBCH, hypotheses of the MIB) based on signaling from the network entity. For example, assuming that the content of the MIB has a set of payloads (e.g., corresponding to a set of versions of the PBCH, a set of two payloads), the PBCH may be associated with a first version (e.g., PBCH1 305) corresponding to the deactivated RMSI 315 (e.g., without RMSI, transmitted when RMSI is not activated), and the PBCH may be associated with a second version (e.g., PBCH2 310) corresponding to the activated RMSI 320. In some cases, the set of bits of the MIB (e.g., “pdcch-ConfigSIB1,” a set of 8 bits, a bitmap) of the first version of the PBCH may be repurposed to provide the UL-WUS configuration, and the frequency offset parameter (e.g., k_SSB) of the first version of the PBCH may be set to a reserved value to indicate that the UE may interpret the set of bits of the MIB according to the UL-WUS configuration. The set of bits of the MIB of the second version of the PBCH may be repurposed to provide the RMSI configuration (e.g., RMSI PDCCH configuration), and the frequency offset parameter of the second version of the PBCH may be set to a value corresponding to the resource element offset between one or more SSBs and the RB grid.

Under this assumption, a UE detecting the cell served by the network entity (e.g., for a first time, initial detection) may be in one of two cases. In a first case, the UE may detect the cell while the network entity may not be transmitting RMSIs (e.g., deactivated RMSIs 315) and transmitting the first version of the PBCH, and thus the UE may transmit the UL-WUS 325 to request the activated RMSI 320. In the first case, the UE may initially decode the first version of the PBCH, which may include the UL-WUS configuration in the MIB. Then, the network entity may transmit the activated RMSI 320 with the second version of the PBCH (e.g., PBCH2 310), and the UE may decode the second version of the PBCH, which may include the RMSI configuration in the MIB. In this manner, the UE may decode MIBs including both configurations (e.g., the UL-WUS configuration and the RMSI configuration), and thus determine both versions of the PBCH.

In a second case, the UE may detect the cell while the network entity may be transmitting the activated RMSI 320 (e.g., another UE may have transmitted the UL-WUS 325 and requested the activated RMSI 320). In some cases, the network entity may stop transmitting the RMSI (e.g., transmit the deactivated RMSI 315) at a later time. In this case, the UE may initially decode the second version of the PBCH. At the later time (e.g., over time), the network entity may begin transmitting the first version of the PBCH (e.g., PBCH1 305). At the later time, the UE may perform a correlation between the second version of the PBCH (e.g., already determined by the UE in the second case) and a received PBCH (e.g., a PBCH1 305), and a result of the correlation may be below the correlation threshold, as described herein. Thus, the UE may determine to decode the received PBCH, thus decoding the first version of the PBCH. In this manner, the UE may decode MIBs including both configurations, and thus determine both versions of the PBCH, based on the correlation threshold.

In some cases, the network entity may indicate information associated with the MIB modification scheme, the versions of the PBCH, or both, to the UE. For example, the network entity may indicate (e.g., directly) the one or more versions of the PBCH to the UE. In some examples, the network entity may indicate to the UE how the set of bits of the MIB may be set for each version of the PBCH. As another example, the UE may receive an indication that the network entity may implement the second MIB modification scheme (e.g., on-demand SIB1 features), which may cause the UE to determine that the MIB content may change. In some cases, the network entity may indicate the information associated with the MIB modification scheme or the PBCH versions to the UE in SI (e.g., a SIB1, broadcast signal 210, activated RMSI 320) or other signaling (e.g., the MIB modification indication 215), including control signaling, for example in a field of one or more of the messages.

In some cases, the UE may transmit a request (e.g., the MIB information request 225 of FIG. 2) for the information associated with the PBCH versions, the information associated with the MIB modification scheme, or both. For example, the UE may request an indication of the MIB modification scheme that the network entity uses, a MIB modification period (e.g., as described in the context of the first MIB modification scheme), whether the MIB content has changed, or any combination thereof. In some cases, the network entity may indicate the information associated with the MIB modification scheme, the versions of the PBCH, or both, to the UE, based on receiving the request from the UE.

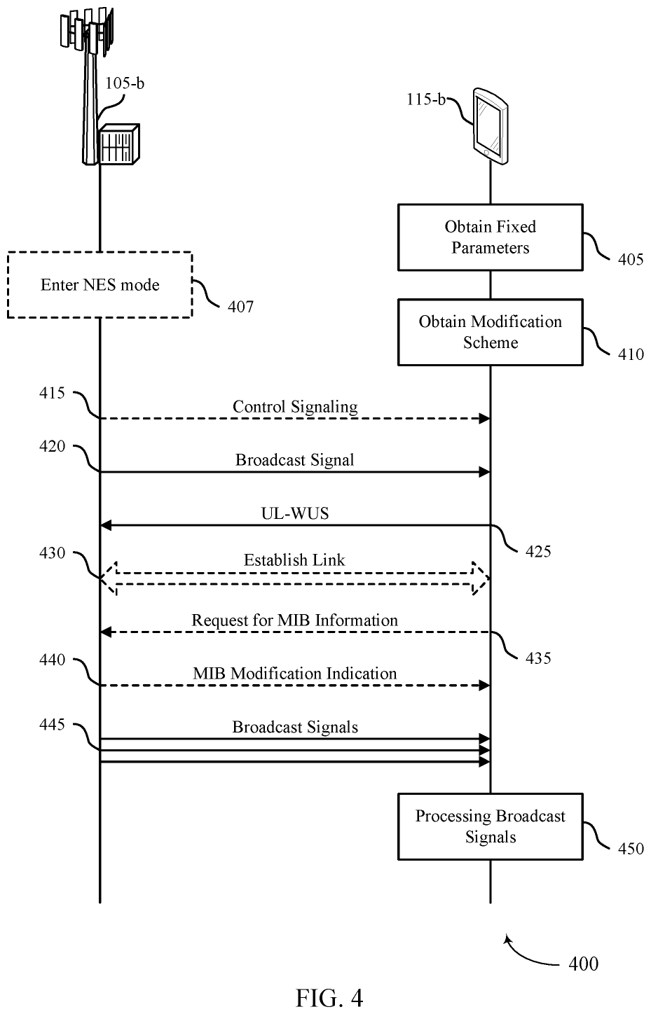

FIG. 4 shows an example of a process flow 400 that supports a MIB modification period in accordance with one or more aspects of the present disclosure. In some cases, aspects of the process flow 400 may implement or be implemented by aspects of FIGS. 1-3. For example, the process flow 400 may include a UE 115-b and a network entity 105-b, which may be examples of UEs 115 and network entities 105, respectively, as described herein with respect to FIGS. 1-3. In some cases, the UE 115-b may transmit an UL-WUS to the network entity 105-b based on one or more fixed parameters and one or more additional (e.g., flexible) parameters, and the UE 115-b may process one or more subsequent broadcast signals according to a MIB modification scheme associated with the UL-WUS.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Although the UE 115-b and the network entity 105-b are shown performing the operations of process flow 400, some aspects of some operations may also be performed by one or more other wireless devices or network devices.

At 405, the UE 115-b may obtain one or more fixed parameters associated with a configuration for an UL-WUS associated with the UE 115-b. In some cases, the one or more fixed parameters may include a preamble associated with the UL-WUS, a quantity of synchronization signal blocks per wakeup signal occasion, a root sequence index associated with the UL-WUS, a subcarrier spacing associated with the UL-WUS, a frequency division multiplexing parameter associated with the uplink wakeup signal, a frequency domain location associated with the UL-WUS, a target power level associated with the UL-WUS, a threshold quantity of transmission attempts of the UL-WUS, or any combination thereof (e.g., as described herein with respect to FIG. 2 and Tables 1 and 2). In some cases, the UE 115-b may obtain the one or more fixed parameters via a preconfiguration including one or more fixed parameters, for example, from one or more standards documents. Additionally, the UE 115-b may obtain one or more fixed parameters as described herein via signaling from the network entity 105-b (e.g., as described at 415).

At 407, the network entity may enter an NES mode. In some cases, the network entity 105-b may be in an NES mode for one or more operations of the process flow 400, including transmitting broadcast signals (e.g., at 420, at 445) and receiving the UL-WUS (e.g., at 425).

At 410, the UE 115-b may obtain an indication of a MIB modification scheme (e.g., as described herein with respect to FIG. 3) associated with a content change for at least a portion (e.g., a set of bits in the MIB) of a broadcast signal. In some cases, the indicated MIB modification scheme may indicate a modification periodicity of an initial content change boundary (e.g., the initial content change boundary 330 of FIG. 3, 345 of FIG. 3). In some cases, the UE 115-b may receive signaling indicating the MIB modification scheme from the network entity 105-b, from a second network entity (e.g., different from the network entity 105-b), or both. For example, the signaling indicating the MIB modification scheme may include an RRC message or a SIB (e.g., SIB1) indicating the MIB modification scheme. In some cases, the MIB modification scheme may be common for communications via a set of frequencies (e.g., bandwidths, resource blocks), for cells within a group, or both.

At 415, the network entity 105-b may output control signaling (e.g., to the UE 115-b) indicating a correlation threshold associated with the one or more subsequent broadcast signals and the one or more versions of the broadcast signals (e.g., as described herein with respect to FIG. 3, and as described with respect to 450). Additionally, or alternatively, the control signaling may indicate the one or more fixed parameters (e.g., RRC signaling, SIB1 signaling).

At 420, the UE 115-b may receive (e.g., from a network entity) a broadcast signal indicating at least one additional (e.g., flexible, configurable) parameter associated with the configuration for the UL-WUS. In some cases, the at least one additional parameter may be different from the one or more fixed parameters. Additionally, or alternatively, one or more wakeup signal occasions associated with the configuration for the UL-WUS may be separate from one or more ROs associated with a random access procedure. In some cases, the broadcast signal may include a bitmap (e.g., a set of bits, 8 bits in a field) that indicates the at least one additional parameter. In some examples, the at least one additional parameter may indicate a preamble type, a sequence length, a transmission time, or any combination thereof, associated with the UL-WUS. In some cases, the broadcast signal may be a PBCH transmission (e.g., such as PBCH1 305 or PBCH2 310 of FIG. 3) or a MIB included in a PBCH (e.g., as described herein with respect to FIG. 2), where the MIB may include the bitmap.

At 425, the UE 115-b may transmit an UL-WUS (e.g., such as the UL-WUS 220 of FIG. 2, the UL-WUS 325 of FIG. 3) during a wakeup signal occasion of the one or more wakeup signal occasions (e.g., separate from the ROs) based on the one or more fixed parameters and on the at least one additional parameter. In some cases, the network entity 105-b may temporarily end the NES mode of 407 based on receiving the UL-WUS from the UE 115-b. Additionally, or alternatively, the network entity 105-b may transmit at least one RMSI (e.g., activated RMSI 320 of FIG. 3) and perform a content change to the broadcast signal (e.g., PBCH2 310 of FIG. 3) based one receiving the UL-WUS from the UE 115-b.

At 430, the UE 115-b may establish a link with the network entity based on transmitting the UL-WUS. In some cases, establishing the link may include communicating one or more RACH messages between the network entity 105-b and the UE 115-b. In some cases, after establishing the link between the UE 115-b and the network entity 105-b, the network entity 105-b may start an NES mode (e.g., enter an NES mode).

At 435, the UE 115-b may transmit (e.g., to the network entity 105-b) a request (e.g., such as the MIB information request 225 of FIG. 2) for information associated with a MIB modification scheme for at least a portion (e.g., the MIB, the set of bits in the MIB indicating the UL-WUS configuration) of the broadcast signal. Additionally, or alternatively, the UE 115-b may transmit (e.g., to the network entity 105-b) a request (e.g., such as the MIB information request 225 of FIG. 2) for information associated with a content change in at least the portion of the broadcast signal, or both.

At 440, the UE 115-b may receive signaling (e.g., such as the MIB modification indication 215 of FIG. 2) indicating a content change in at least the portion of the broadcast signal. In some cases, the signaling may indicate information associated with one or more versions (e.g., PBCH1 305, PBCH2 310 of FIG. 3) of the broadcast signal, as described herein with respect to FIG. 3 and the MIB modification indication 215. In some cases, receiving the signaling may include receiving a PDCCH transmission, a PDSCH transmission, or both, indicating the content change in at least the portion of the broadcast signal, where the UE 115-b may receive the PDCCH transmission, the PDSCH transmission, or both, based on establishing the link with the network entity at 430. In some cases, the signaling of 440 may also indicate the MIB modification scheme (e.g., as described herein with respect to FIG. 3) implemented by the network entity 105-b, the MIB modification scheme associated with the content change for at least the portion of the broadcast signal.

At 445, the network entity 105-b may output one or more subsequent broadcast signals (e.g., subsequent to the broadcast signal of 420, PBCH1s 305, PBCH2s 310 of FIG. 3) based on the content change (e.g., the one or more subsequent broadcast signals may include the content change).

Additionally, or alternatively, the network entity 105-b may output the one or more subsequent broadcast signals based on the MIB modification scheme. For example, (e.g., according to the first MIB modification scheme), the network entity 105-b may perform a content change of at least the portion of the one or more subsequent broadcast signals after an initial content change boundary (e.g., the initial content change boundary 330 of FIG. 3) that occurs after the network entity 105-b obtains the UL-WUS at the network entity 105-b. As another example (e.g., according to the second MIB modification scheme), the network entity 105-b may perform the content change of at least the portion of the one or more subsequent broadcast signals before the initial content change boundary, where the initial content change boundary may be a temporally first (e.g., next, immediately subsequent) initial content change boundary after the network entity 105-b obtains the UL-WUS. As yet another example (e.g., and still according to the second MIB modification scheme), the network entity 105-b may perform the content change of at least the portion of a second broadcast signal that is a temporally first broadcast signal broadcasted after the network entity 105-b obtains the UL-WUS (e.g., the PBCH2 310-a of FIG. 3).

At 450, the UE 115-b may process the one or more subsequent broadcast signals. For example, the UE 115-b may process the one or more subsequent broadcast signals based on the modification scheme. In some cases, the UE may (e.g., according to the first MIB modification scheme) process the one or more subsequent broadcast signals after the initial content change boundary that occurs after transmission of the UL-WUS (e.g., as described herein with respect to FIG. 3). In some cases, the UE may (e.g., according to the second MIB modification scheme) process the one or more subsequent broadcast signals before the initial content change boundary (as described herein with respect to FIG. 3). In some cases, the one or more subsequent broadcast signals may include the second broadcast signal that is a temporally first broadcast signal broadcasted after transmission of the UL-WUS (e.g., the PBCH2 310-a of FIG. 3).

Additionally, or alternatively, the UE 115-b may process the one or more subsequent broadcast signals based on the signaling indicating the content change (e.g., such as the MIB modification indication 215 of FIG. 2). For example, the UE 115-b may configure one or more beam parameters (e.g., receive beam parameters, tracking, beam management) based on determining whether a correlation between a subsequent broadcast signal of the one or more subsequent broadcast signals and a version of one or more versions of the broadcast signal satisfies a correlation threshold (e.g., as described herein with respect to FIG. 3). In some cases, the UE 115-b may determine the correlation threshold from a set of one or more correlation thresholds, for example, based on previously recorded correlation data stored at the UE 115-b or the network entity 105-b.

According to the techniques described herein, the UE 115-b may receive flexible UL-WUS configuration for the cell that the network entity 105-b serves which easily integrates with broadcast signaling performed between the network entity 105-b and the UE 115-b.

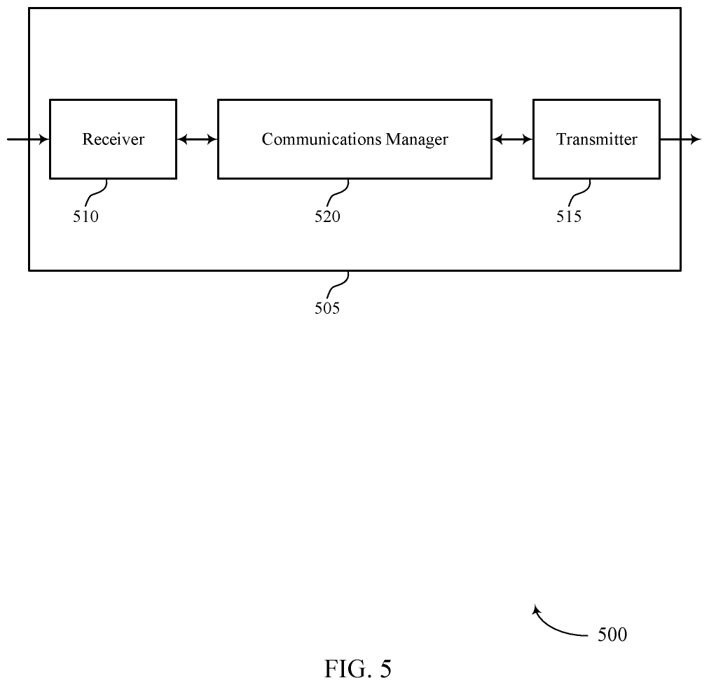

FIG. 5 shows a block diagram 500 of a device 505 that supports MIB modification period in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to MIB modification period). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to MIB modification period). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of MIB modification period as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for obtaining one or more fixed parameters associated with a configuration for an UL-WUS associated with the UE. The communications manager 520 is capable of, configured to, or operable to support a means for receiving, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more ROs associated with a random access procedure. The communications manager 520 is capable of, configured to, or operable to support a means for transmitting the UL-WUS during a wakeup signal occasion of the one or more wakeup signal occasions based on the one or more fixed parameters and on the at least one additional parameter.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources. For example, a UE implementing the techniques described herein may transmit a flexibly configured UL-WUS to a network entity without receiving all of the UL-WUS configuration over the air (e.g., the one or more fixed parameters may be preconfigured from one or more standards documents).

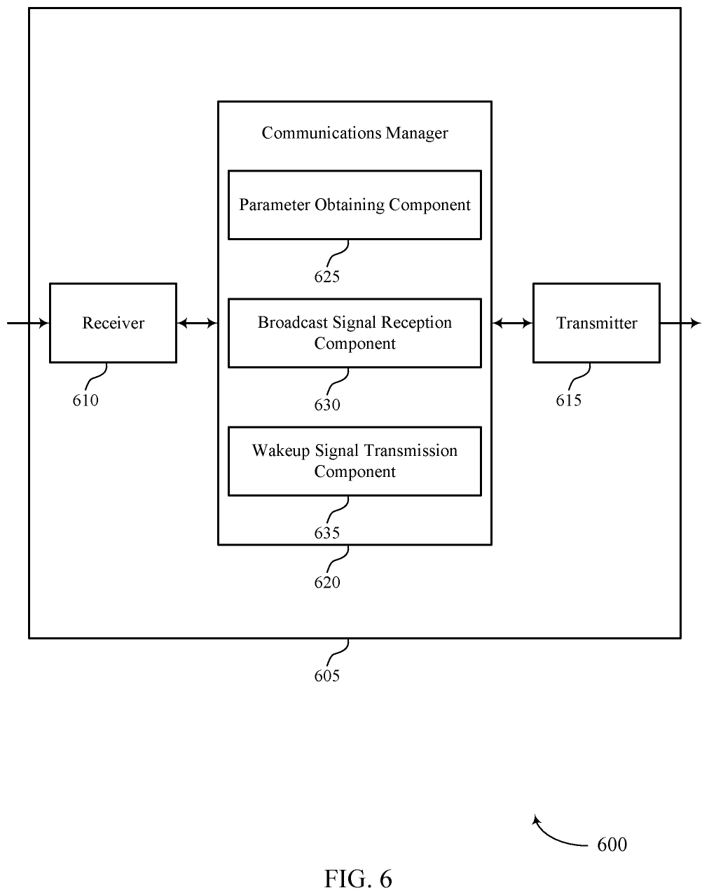

FIG. 6 shows a block diagram 600 of a device 605 that supports MIB modification period in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to MIB modification period). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to MIB modification period). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of MIB modification period as described herein. For example, the communications manager 620 may include a parameter obtaining component 625, a broadcast signal reception component 630, a wakeup signal transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The parameter obtaining component 625 is capable of, configured to, or operable to support a means for obtaining one or more fixed parameters associated with a configuration for an UL-WUS associated with the UE. The broadcast signal reception component 630 is capable of, configured to, or operable to support a means for receiving, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more ROs associated with a random access procedure. The wakeup signal transmission component 635 is capable of, configured to, or operable to support a means for transmitting the UL-WUS during a wakeup signal occasion of the one or more wakeup signal occasions based on the one or more fixed parameters and on the at least one additional parameter.

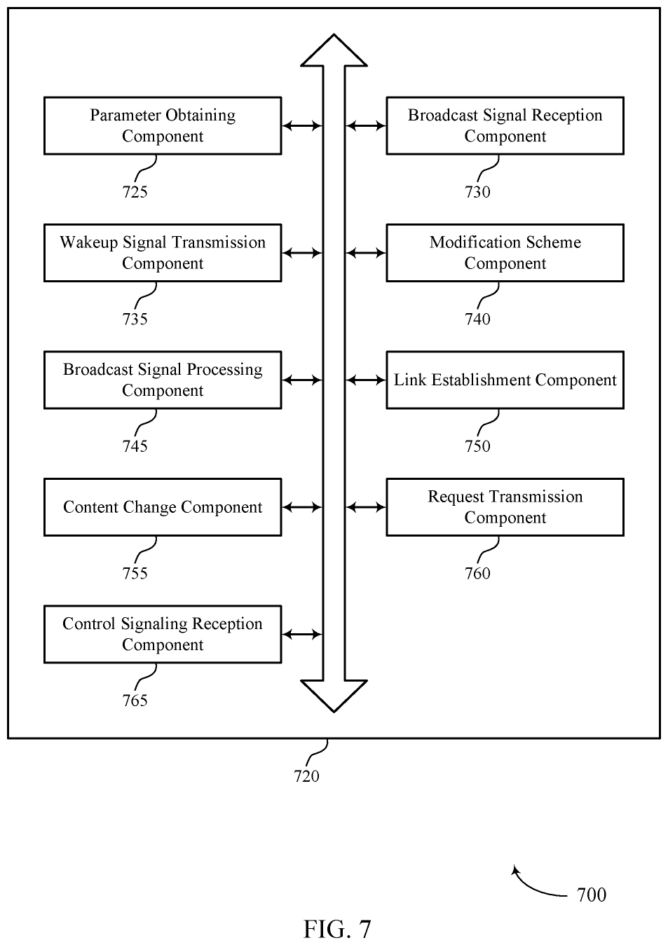

FIG. 7 shows a block diagram 700 of a communications manager 720 that supports MIB modification period in accordance with one or more aspects of the present disclosure. The communications manager 720 may be an example of aspects of a communications manager 520, a communications manager 620, or both, as described herein. The communications manager 720, or various components thereof, may be an example of means for performing various aspects of MIB modification period as described herein. For example, the communications manager 720 may include a parameter obtaining component 725, a broadcast signal reception component 730, a wakeup signal transmission component 735, a modification scheme component 740, a broadcast signal processing component 745, a link establishment component 750, a content change component 755, a request transmission component 760, a control signaling reception component 765, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The parameter obtaining component 725 is capable of, configured to, or operable to support a means for obtaining one or more fixed parameters associated with a configuration for an UL-WUS associated with the UE. The broadcast signal reception component 730 is capable of, configured to, or operable to support a means for receiving, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more ROs associated with a random access procedure. The wakeup signal transmission component 735 is capable of, configured to, or operable to support a means for transmitting the UL-WUS during a wakeup signal occasion of the one or more wakeup signal occasions based on the one or more fixed parameters and on the at least one additional parameter.

In some examples, the modification scheme component 740 is capable of, configured to, or operable to support a means for obtaining an indication of a modification scheme associated with a content change for at least a portion of the broadcast signal. In some examples, the broadcast signal processing component 745 is capable of, configured to, or operable to support a means for processing one or more subsequent broadcast signals based on the modification scheme.

In some examples, the modification scheme indicates a modification periodicity of an initial content change boundary.

In some examples, to support processing the one or more subsequent broadcast signals based on the modification scheme, the broadcast signal processing component 745 is capable of, configured to, or operable to support a means for processing the one or more subsequent broadcast signals after an initial content change boundary that occurs after transmission of the UL-WUS.

In some examples, to support processing the one or more subsequent broadcast signals based on the modification scheme, the broadcast signal processing component 745 is capable of, configured to, or operable to support a means for processing the one or more subsequent broadcast signals before an initial content change boundary, where the initial content change boundary is a temporally first initial content change boundary after transmission of the UL-WUS.

In some examples, the one or more subsequent broadcast signals includes a second broadcast signal that is a temporally first broadcast signal broadcasted after transmission of the UL-WUS.

In some examples, to support obtaining the indication of the modification scheme, the modification scheme component 740 is capable of, configured to, or operable to support a means for receiving signaling indicating the modification scheme from the network entity, from a second network entity, or both.

In some examples, to support obtaining the indication of the modification scheme, the modification scheme component 740 is capable of, configured to, or operable to support a means for receiving a RRC message or a SIB indicating the modification scheme.

In some examples, the modification scheme is common for communications via a set of frequencies, for cells within a group, or both.

In some examples, the link establishment component 750 is capable of, configured to, or operable to support a means for establishing a link with the network entity based on transmitting the UL-WUS. In some examples, the content change component 755 is capable of, configured to, or operable to support a means for receiving signaling indicating a content change in at least a portion of the broadcast signal. In some examples, the broadcast signal processing component 745 is capable of, configured to, or operable to support a means for processing one or more subsequent broadcast signals based on the signaling indicating the content change.

In some examples, to support receiving the signaling indicating the content change, the content change component 755 is capable of, configured to, or operable to support a means for receiving information associated with one or more versions of the broadcast signal.

In some examples, to support processing the one or more subsequent broadcast signals, the broadcast signal processing component 745 is capable of, configured to, or operable to support a means for configuring one or more receive beam parameters based on determining whether a correlation between a subsequent broadcast signal of the one or more subsequent broadcast signals and a version of the one or more versions of the broadcast signal satisfies a correlation threshold.

In some examples, the control signaling reception component 765 is capable of, configured to, or operable to support a means for determining the correlation threshold from a set of one or more correlation thresholds.

In some examples, to support receiving the signaling indicating the content change, the content change component 755 is capable of, configured to, or operable to support a means for receiving a physical downlink control channel transmission or a physical downlink shared channel transmission indicating the content change in at least the portion of the broadcast signal based on establishing the link with the network entity.

In some examples, the request transmission component 760 is capable of, configured to, or operable to support a means for transmitting a request for information associated with a modification scheme for at least a portion of the broadcast signal, a request for information associated with a content change in at least the portion of the broadcast signal, or both.

In some examples, the broadcast signal includes a bitmap that indicates the at least one additional parameter. In some examples, the at least one additional parameter indicates a preamble type, a sequence length, a transmission time, or any combination thereof, associated with the UL-WUS.

In some examples, the one or more fixed parameters include a preamble associated with the UL-WUS, a quantity of synchronization signal blocks per wakeup signal occasion, a root sequence index associated with the UL-WUS, a subcarrier spacing associated with the UL-WUS, a frequency division multiplexing parameter associated with the UL-WUS, a frequency domain location associated with the UL-WUS, a target power level associated with the UL-WUS, a threshold quantity of transmission attempts of the UL-WUS, or any combination thereof.

In some examples, to support obtaining the one or more fixed parameters, the control signaling reception component 765 is capable of, configured to, or operable to support a means for receiving control signaling indicating the one or more fixed parameters.

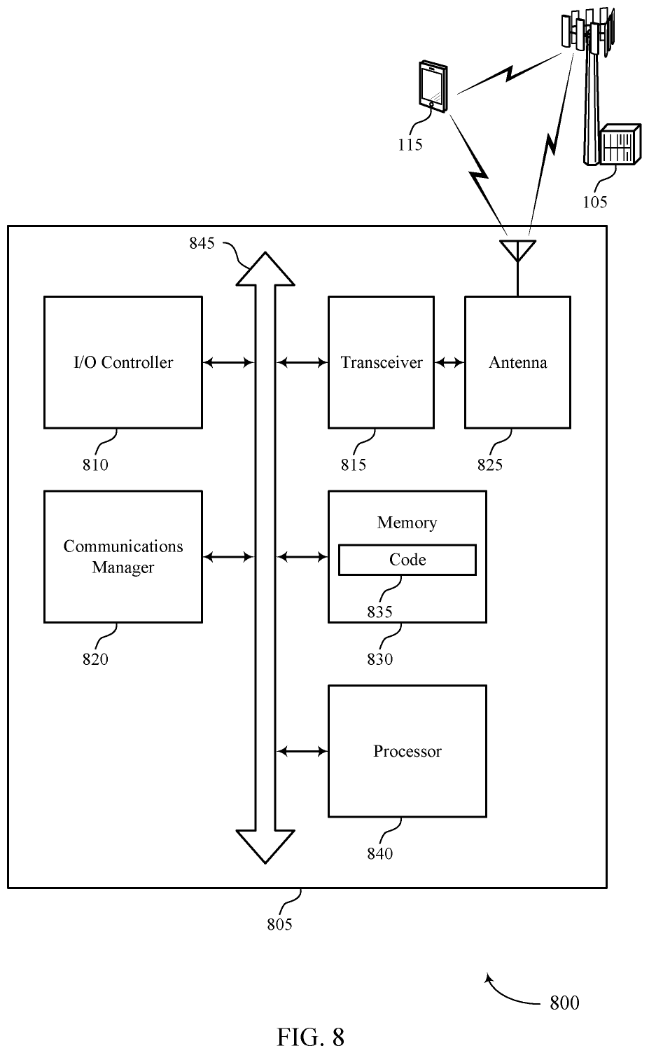

FIG. 8 shows a diagram of a system 800 including a device 805 that supports MIB modification period in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting MIB modification period). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for obtaining one or more fixed parameters associated with a configuration for an UL-WUS associated with the UE. The communications manager 820 is capable of, configured to, or operable to support a means for receiving, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more ROs associated with a random access procedure. The communications manager 820 is capable of, configured to, or operable to support a means for transmitting the UL-WUS during a wakeup signal occasion of the one or more wakeup signal occasions based on the one or more fixed parameters and on the at least one additional parameter.

By including or configuring the communications manager 820 in accordance with examples as described herein, the device 805 may support techniques for improved communication reliability between devices. For example, a UE implementing the techniques described herein may transmit an UL-WUS according to a configuration for a specific network entity, leading to increased reliability of reception and successful connection for the UE.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of MIB modification period as described herein, or the at least one processor 840 and the at least one memory 830 may be otherwise configured to, individually or collectively, perform or support such operations.

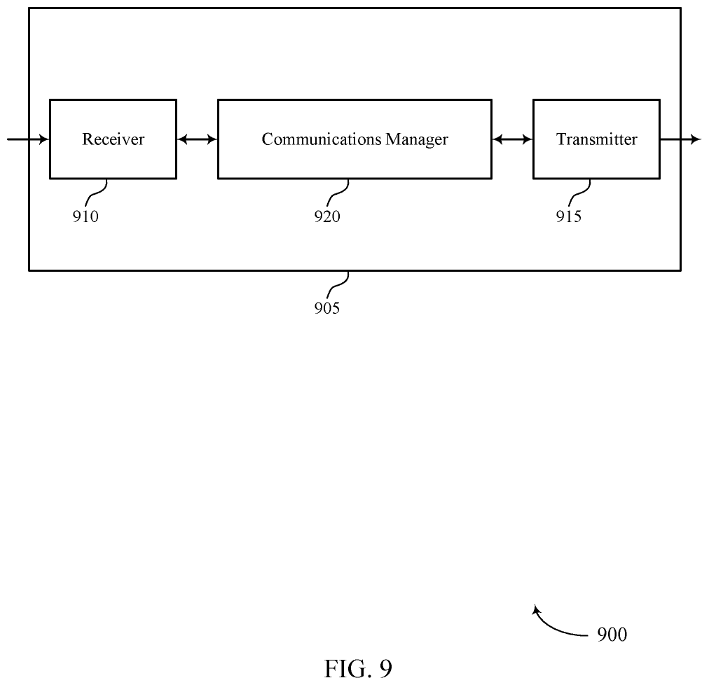

FIG. 9 shows a block diagram 900 of a device 905 that supports MIB modification period in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of MIB modification period as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for outputting a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more ROs associated with a random access procedure. The communications manager 920 is capable of, configured to, or operable to support a means for obtaining, for a UE the UL-WUS during a wakeup signal occasion of the one or more wakeup signal occasions based on the one or more fixed parameters and on the at least one additional parameter.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources. For example, a network entity implementing the techniques described herein may receive a flexibly configured UL-WUS from a UE without transmitting all of the UL-WUS configuration over the air (e.g., the one or more fixed parameters may be preconfigured to the UE from one or more standards documents).

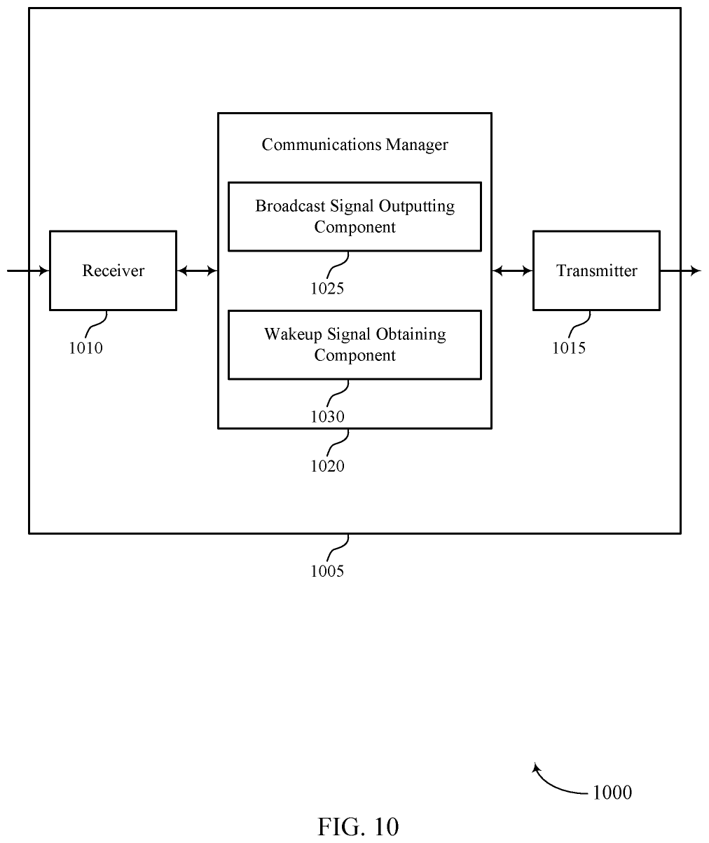

FIG. 10 shows a block diagram 1000 of a device 1005 that supports MIB modification period in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of MIB modification period as described herein. For example, the communications manager 1020 may include a broadcast signal outputting component 1025 a wakeup signal obtaining component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The broadcast signal outputting component 1025 is capable of, configured to, or operable to support a means for outputting a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more ROs associated with a random access procedure. The wakeup signal obtaining component 1030 is capable of, configured to, or operable to support a means for obtaining, for a UE the UL-WUS during a wakeup signal occasion of the one or more wakeup signal occasions based on the one or more fixed parameters and on the at least one additional parameter.

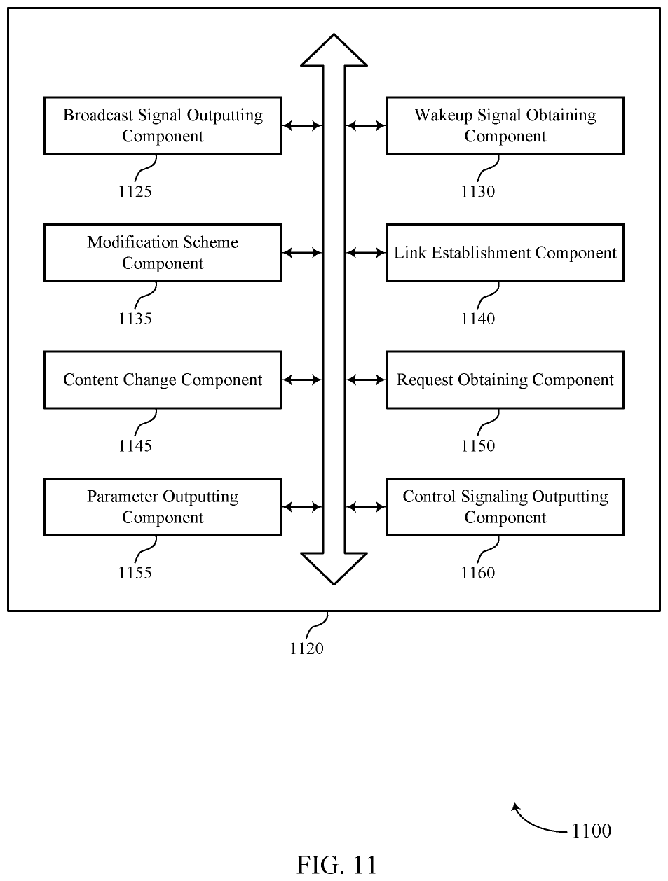

FIG. 11 shows a block diagram 1100 of a communications manager 1120 that supports MIB modification period in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of MIB modification period as described herein. For example, the communications manager 1120 may include a broadcast signal outputting component 1125, a wakeup signal obtaining component 1130, a modification scheme component 1135, a link establishment component 1140, a content change component 1145, a request obtaining component 1150, a parameter outputting component 1155, a control signaling outputting component 1160, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The broadcast signal outputting component 1125 is capable of, configured to, or operable to support a means for outputting a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more ROs associated with a random access procedure. The wakeup signal obtaining component 1130 is capable of, configured to, or operable to support a means for obtaining, for a UE the UL-WUS during a wakeup signal occasion of the one or more wakeup signal occasions based on the one or more fixed parameters and on the at least one additional parameter.

In some examples, the modification scheme component 1135 is capable of, configured to, or operable to support a means for outputting an indication of a modification scheme associated with a content change for at least a portion of the broadcast signal. In some examples, the broadcast signal outputting component 1125 is capable of, configured to, or operable to support a means for outputting one or more subsequent broadcast signals based on the modification scheme.

In some examples, the modification scheme indicates a modification periodicity of an initial content change boundary.

In some examples, to support outputting the one or more subsequent broadcast signals based on the modification scheme, the broadcast signal outputting component 1125 is capable of, configured to, or operable to support a means for performing a content change of at least a portion of the one or more subsequent broadcast signals after an initial content change boundary that occurs after the UL-WUS is obtained.

In some examples, to support outputting the one or more subsequent broadcast signals based on the modification scheme, the broadcast signal outputting component 1125 is capable of, configured to, or operable to support a means for performing a content change of at least a portion of the one or more subsequent broadcast signals before an initial content change boundary, where the initial content change boundary is a temporally first initial content change boundary after the UL-WUS is obtained.

In some examples, to support outputting the one or more subsequent broadcast signals based on the modification scheme, the broadcast signal outputting component 1125 is capable of, configured to, or operable to support a means for performing a content change of at least a portion of a second broadcast signal that is a temporally first broadcast signal broadcasted after the UL-WUS is obtained.

In some examples, to support outputting the indication of the modification scheme, the modification scheme component 1135 is capable of, configured to, or operable to support a means for outputting a RRC message or a SIB indicating the modification scheme.

In some examples, the modification scheme is common for communications via a set of frequencies, for cells within a group, or both.

In some examples, the link establishment component 1140 is capable of, configured to, or operable to support a means for establishing a link with the UE based on the UL-WUS. In some examples, the content change component 1145 is capable of, configured to, or operable to support a means for outputting signaling indicating a content change in at least a portion of the broadcast signal. In some examples, the broadcast signal outputting component 1125 is capable of, configured to, or operable to support a means for outputting one or more subsequent broadcast signals based on the content change.

In some examples, to support outputting the signaling indicating the content change, the content change component 1145 is capable of, configured to, or operable to support a means for outputting information associated with one or more versions of the broadcast signal.

In some examples, the control signaling outputting component 1160 is capable of, configured to, or operable to support a means for outputting control signaling indicating a correlation threshold associated with the one or more subsequent broadcast signals and the one or more versions of the broadcast signal.

In some examples, to support outputting the signaling indicating the content change, the content change component 1145 is capable of, configured to, or operable to support a means for outputting a physical downlink control channel transmission or a physical downlink shared channel transmission indicating the content change in at least the portion of the broadcast signal based on establishing the link with the UE.

In some examples, the request obtaining component 1150 is capable of, configured to, or operable to support a means for obtaining a request for information associated with a modification scheme for at least a portion of the broadcast signal, a request for information associated with a content change in at least the portion of the broadcast signal, or both.

In some examples, the broadcast signal includes a bitmap that indicates the at least one additional parameter. In some examples, the at least one additional parameter indicates a preamble type, a sequence length, a transmission time, or any combination thereof, associated with the UL-WUS.

In some examples, the one or more fixed parameters include a preamble associated with the UL-WUS, a quantity of synchronization signal blocks per wakeup signal occasion, a root sequence index associated with the UL-WUS, a subcarrier spacing associated with the UL-WUS, a frequency division multiplexing parameter associated with the UL-WUS, a frequency domain location associated with the UL-WUS, a target power level associated with the UL-WUS, a threshold quantity of transmission attempts of the UL-WUS, or any combination thereof.

In some examples, the parameter outputting component 1155 is capable of, configured to, or operable to support a means for outputting, to the UE, the one or more fixed parameters.

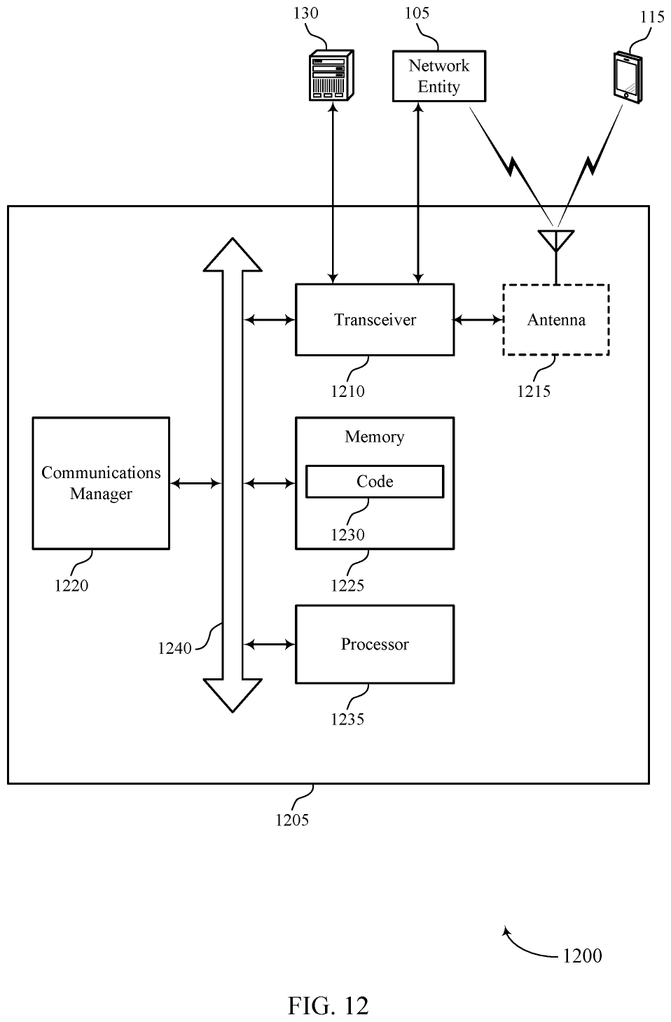

FIG. 12 shows a diagram of a system 1200 including a device 1205 that supports MIB modification period in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting MIB modification period). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network devices 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 is capable of, configured to, or operable to support a means for outputting a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more ROs associated with a random access procedure. The communications manager 1220 is capable of, configured to, or operable to support a means for obtaining, for a UE the UL-WUS during a wakeup signal occasion of the one or more wakeup signal occasions based on the one or more fixed parameters and on the at least one additional parameter.

By including or configuring the communications manager 1220 in accordance with examples as described herein, the device 1205 may support techniques for improved communication reliability between devices. For example, a network entity implementing the techniques described herein may receive an UL-WUS according to a configuration for the network entity, leading to increased reliability of reception and successful connection with the UE.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described herein with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of MIB modification period as described herein, or the at least one processor 1235 and the at least one memory 1225 may be otherwise configured to, individually or collectively, perform or support such operations.

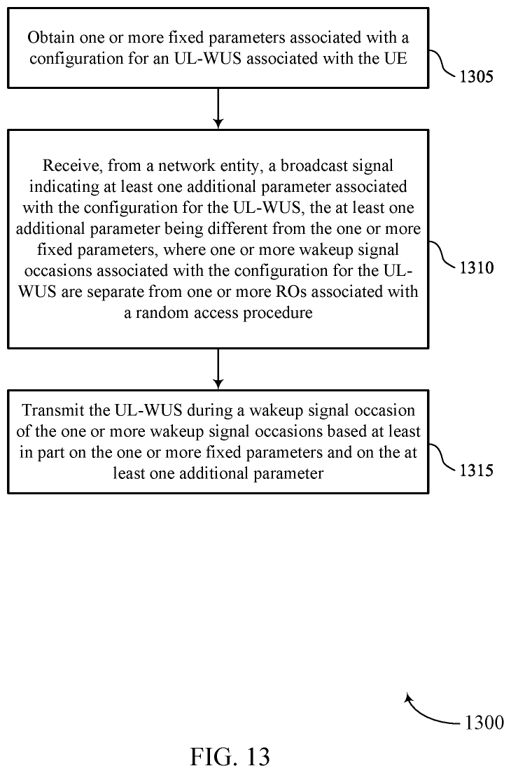

FIG. 13 shows a flowchart illustrating a method 1300 that supports MIB modification period in accordance with one or more aspects of the present disclosure. The operations of the method 1300 may be implemented by a UE or its components as described herein. For example, the operations of the method 1300 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include obtaining one or more fixed parameters associated with a configuration for an UL-WUS associated with the UE. The operations of 1305 may be performed in accordance with examples as disclosed herein. In some examples, aspects of the operations of 1305 may be performed by a parameter obtaining component 725 as described herein with reference to FIG. 7.

At 1310, the method may include receiving, from a network entity, a broadcast signal indicating at least one additional parameter associated with the configuration for the UL-WUS, the at least one additional parameter being different from the one or more fixed parameters, where one or more wakeup signal occasions associated with the configuration for the UL-WUS are separate from one or more ROs associated with a random access procedure. The operations of 1310 may be performed in accordance with examples as disclosed herein. In some examples, aspects of the operations of 1310 may be performed by a broadcast signal reception component 730 as described herein with reference to FIG. 7.

At 1315, the method may include transmitting the UL-WUS during a wakeup signal occasion of the one or more wakeup signal occasions based at least in part on the one or more fixed parameters and on the at least one additional parameter. The operations of 1315 may be performed in accordance with examples as disclosed herein. In some examples, aspects of the operations of 1315 may be performed by a wakeup signal transmission component 735 as described herein with reference to FIG. 7.

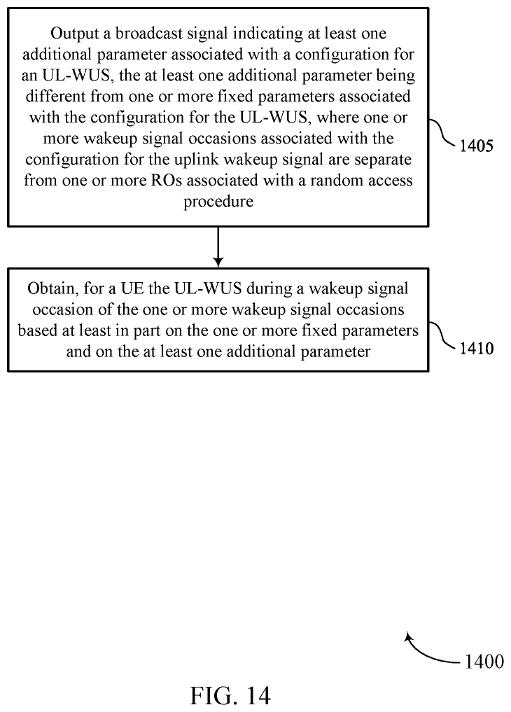

FIG. 14 shows a flowchart illustrating a method 1400 that supports MIB modification period in accordance with one or more aspects of the present disclosure. The operations of the method 1400 may be implemented by a network entity or its components as described herein. For example, the operations of the method 1400 may be performed by a network entity as described herein with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting a broadcast signal indicating at least one additional parameter associated with a configuration for an UL-WUS, the at least one additional parameter being different from one or more fixed parameters associated with the configuration for the UL-WUS, where one or more wakeup signal occasions associated with the configuration for the UL-WUS are separate from one or more ROs associated with a random access procedure. The operations of 1405 may be performed in accordance with examples as disclosed herein. In some examples, aspects of the operations of 1405 may be performed by a broadcast signal outputting component 1125 as described herein with reference to FIG. 11.

At 1410, the method may include obtaining, for a UE the UL-WUS during a wakeup signal occasion of the one or more wakeup signal occasions based at least in part on the one or more fixed parameters and on the at least one additional parameter. The operations of 1410 may be performed in accordance with examples as disclosed herein. In some examples, aspects of the operations of 1410 may be performed by a wakeup signal obtaining component 1130 as described herein with reference to FIG. 11.

The following provides an overview of aspects of the present disclosure:

Aspect 1: A method for wireless communication at a UE, comprising: obtaining one or more fixed parameters associated with a configuration for an UL-WUS associated with the UE; receiving, from a network entity, a broadcast signal indicating at least one additional parameter associated with the configuration for the UL-WUS, the at least one additional parameter being different from the one or more fixed parameters, wherein one or more wakeup signal occasions associated with the configuration for the UL-WUS are separate from one or more random access occasions associated with a random access procedure; and transmitting the UL-WUS during a wakeup signal occasion of the one or more wakeup signal occasions based at least in part on the one or more fixed parameters and on the at least one additional parameter.

Aspect 2: The method of aspect 1, further comprising: obtaining an indication of a modification scheme associated with a content change for at least a portion of the broadcast signal; and processing one or more subsequent broadcast signals based at least in part on the modification scheme.

Aspect 3: The method of aspect 2, wherein the modification scheme indicates a modification periodicity of an initial content change boundary.

Aspect 4: The method of any of aspects 2 through 3, wherein processing the one or more subsequent broadcast signals based at least in part on the modification scheme comprises: processing the one or more subsequent broadcast signals after an initial content change boundary that occurs after transmission of the UL-WUS.

Aspect 5: The method of any of aspects 2 through 3, wherein processing the one or more subsequent broadcast signals based at least in part on the modification scheme comprises: processing the one or more subsequent broadcast signals before an initial content change boundary, wherein the initial content change boundary is a temporally first initial content change boundary after transmission of the UL-WUS.

Aspect 6: The method of any of aspects 2 through 3 and 5, wherein the one or more subsequent broadcast signals comprises a second broadcast signal that is a temporally first broadcast signal broadcasted after transmission of the UL-WUS.

Aspect 7: The method of any of aspects 2 through 6, wherein obtaining the indication of the modification scheme comprises: receiving signaling indicating the modification scheme from the network entity, from a second network entity, or both.

Aspect 8: The method of any of aspects 2 through 7, wherein obtaining the indication of the modification scheme comprises: receiving an RRC message or a SIB indicating the modification scheme.

Aspect 9: The method of any of aspects 2 through 8, wherein the modification scheme is common for communications via a set of frequencies, for cells within a group, or both.

Aspect 10: The method of any of aspects 1 through 9, further comprising: establishing a link with the network entity based at least in part on transmitting the UL-WUS; receiving signaling indicating a content change in at least a portion of the broadcast signal; and processing one or more subsequent broadcast signals based at least in part on the signaling indicating the content change.

Aspect 11: The method of aspect 10, wherein receiving the signaling indicating the content change comprises: receiving information associated with one or more versions of the broadcast signal.

Aspect 12: The method of aspect 11, wherein processing the one or more subsequent broadcast signals comprises: configuring one or more receive beam parameters based at least in part on determining whether a correlation between a subsequent broadcast signal of the one or more subsequent broadcast signals and a version of the one or more versions of the broadcast signal satisfies a correlation threshold.

Aspect 13: The method of aspect 12, further comprising: determining the correlation threshold from a set of one or more correlation thresholds.

Aspect 14: The method of any of aspects 10 through 13, wherein receiving the signaling indicating the content change comprises: receiving a PDCCH transmission or a PDSCH transmission indicating the content change in at least the portion of the broadcast signal based at least in part on establishing the link with the network entity.

Aspect 15: The method of any of aspects 1 through 14, further comprising: transmitting a request for information associated with a modification scheme for at least a portion of the broadcast signal, a request for information associated with a content change in at least the portion of the broadcast signal, or both.

Aspect 16: The method of any of aspects 1 through 15, wherein the broadcast signal comprises a bitmap that indicates the at least one additional parameter, and the at least one additional parameter indicates a preamble type, a sequence length, a transmission time, or any combination thereof, associated with the UL-WUS.

Aspect 17: The method of any of aspects 1 through 16, wherein the one or more fixed parameters comprise a preamble associated with the UL-WUS, a quantity of synchronization signal blocks per wakeup signal occasion, a root sequence index associated with the UL-WUS, a subcarrier spacing associated with the UL-WUS, a frequency division multiplexing parameter associated with the UL-WUS, a frequency domain location associated with the UL-WUS, a target power level associated with the UL-WUS, a threshold quantity of transmission attempts of the UL-WUS, or any combination thereof.

Aspect 18: The method of aspect 17, wherein obtaining the one or more fixed parameters comprises: receiving control signaling indicating the one or more fixed parameters.

Aspect 19: A method for wireless communication at a network entity, comprising: outputting a broadcast signal indicating at least one additional parameter associated with a configuration for an UL-WUS, the at least one additional parameter being different from one or more fixed parameters associated with the configuration for the UL-WUS, wherein one or more wakeup signal occasions associated with the configuration for the UL-WUS are separate from one or more random access occasions associated with a random access procedure; and obtaining, for a UE the UL-WUS during a wakeup signal occasion of the one or more wakeup signal occasions based at least in part on the one or more fixed parameters and on the at least one additional parameter.

Aspect 20: The method of aspect 19, further comprising: outputting an indication of a modification scheme associated with a content change for at least a portion of the broadcast signal; and outputting one or more subsequent broadcast signals based at least in part on the modification scheme.

Aspect 21: The method of aspect 20, wherein the modification scheme indicates a modification periodicity of an initial content change boundary.

Aspect 22: The method of any of aspects 20 through 21, wherein outputting the one or more subsequent broadcast signals based at least in part on the modification scheme comprises: performing a content change of at least a portion of the one or more subsequent broadcast signals after an initial content change boundary that occurs after the UL-WUS is obtained.

Aspect 23: The method of any of aspects 20 through 21, wherein outputting the one or more subsequent broadcast signals based at least in part on the modification scheme comprises: performing a content change of at least a portion of the one or more subsequent broadcast signals before an initial content change boundary, wherein the initial content change boundary is a temporally first initial content change boundary after the UL-WUS is obtained.

Aspect 24: The method of any of aspects 20 through 21 and 23, wherein outputting the one or more subsequent broadcast signals based at least in part on the modification scheme comprises: performing a content change of at least a portion of a second broadcast signal that is a temporally first broadcast signal broadcasted after the UL-WUS is obtained.

Aspect 25: The method of any of aspects 20 through 24, wherein outputting the indication of the modification scheme comprises: outputting an RRC message or a SIB indicating the modification scheme.

Aspect 26: The method of any of aspects 20 through 25, wherein the modification scheme is common for communications via a set of frequencies, for cells within a group, or both.

Aspect 27: The method of any of aspects 19 through 26, further comprising: establishing a link with the UE based at least in part on the UL-WUS; outputting signaling indicating a content change in at least a portion of the broadcast signal; and outputting one or more subsequent broadcast signals based at least in part on the content change.

Aspect 28: The method of aspect 27, wherein outputting the signaling indicating the content change comprises: outputting information associated with one or more versions of the broadcast signal.

Aspect 29: The method of aspect 28, further comprising: outputting control signaling indicating a correlation threshold associated with the one or more subsequent broadcast signals and the one or more versions of the broadcast signal.

Aspect 30: The method of any of aspects 27 through 29, wherein outputting the signaling indicating the content change comprises: outputting a PDCCH transmission or a PDSCH transmission indicating the content change in at least the portion of the broadcast signal based at least in part on establishing the link with the UE.

Aspect 31: The method of any of aspects 19 through 30, further comprising: obtaining a request for information associated with a modification scheme for at least a portion of the broadcast signal, a request for information associated with a content change in at least the portion of the broadcast signal, or both.

Aspect 32: The method of any of aspects 19 through 31, wherein the broadcast signal comprises a bitmap that indicates the at least one additional parameter, and the at least one additional parameter indicates a preamble type, a sequence length, a transmission time, or any combination thereof, associated with the UL-WUS.

Aspect 33: The method of any of aspects 19 through 32, wherein the one or more fixed parameters comprise a preamble associated with the UL-WUS, a quantity of synchronization signal blocks per wakeup signal occasion, a root sequence index associated with the UL-WUS, a subcarrier spacing associated with the UL-WUS, a frequency division multiplexing parameter associated with the UL-WUS, a frequency domain location associated with the UL-WUS, a target power level associated with the UL-WUS, a threshold quantity of transmission attempts of the UL-WUS, or any combination thereof.

Aspect 34: The method of aspect 33, further comprising: outputting, to the UE, the one or more fixed parameters.

Aspect 35: A UE for wireless communication, comprising at least one processor and at least one memory coupled with the at least one processor, with instructions stored in the at least one memory, the instructions being executable by the at least one processor, individually or in any combination, to cause the apparatus (e.g., the UE) to perform a method of any of aspects 1 through 18.

Aspect 36: A UE for wireless communication, comprising at least one means for performing a method of any of aspects 1 through 18.

Aspect 37: A non-transitory computer-readable medium storing code for wireless communication, the code comprising instructions executable by one or more processors to perform a method of any of aspects 1 through 18.

Aspect 38: A network entity for wireless communication, comprising at least one processor and at least one memory coupled with the at least one processor, with instructions stored in the at least one memory, the instructions being executable by the at least one processor, individually or in any combination, to cause the apparatus (e.g., the network entity) to perform a method of any of aspects 19 through 34.

Aspect 39: A network entity for wireless communication, comprising at least one means for performing a method of any of aspects 19 through 34.

Aspect 40: A non-transitory computer-readable medium storing code for wireless communication, the code comprising instructions executable by one or more processors to perform a method of any of aspects 19 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
at least one memory coupled with the at least one processor, with instructions stored in the at least one memory, the instructions being executable by the at least one processor, individually or in any combination, to cause the apparatus to:
obtain one or more fixed parameters associated with a configuration for an uplink wakeup signal associated with the UE;
receive, from a network entity, a broadcast signal indicating at least one additional parameter associated with the configuration for the uplink wakeup signal, the at least one additional parameter being different from the one or more fixed parameters, wherein one or more wakeup signal occasions associated with the configuration for the uplink wakeup signal are separate from one or more random access occasions associated with a random access procedure; and
transmit the uplink wakeup signal during a wakeup signal occasion of the one or more wakeup signal occasions based at least in part on the one or more fixed parameters and on the at least one additional parameter.

2. The apparatus of claim 1, wherein the instructions are further executable by the at least one processor, individually or in any combination, to cause the apparatus to:
obtain an indication of a modification scheme associated with a content change for at least a portion of the broadcast signal; and
process one or more subsequent broadcast signals based at least in part on the modification scheme.

3. The apparatus of claim 2, wherein the modification scheme indicates a modification periodicity of an initial content change boundary.

4. The apparatus of claim 2, wherein, to process the one or more subsequent broadcast signals based at least in part on the modification scheme, the instructions are executable by the at least one processor, individually or in any combination, to cause the apparatus to:
process the one or more subsequent broadcast signals after an initial content change boundary that occurs after transmission of the uplink wakeup signal.

5. The apparatus of claim 2, wherein, to process the one or more subsequent broadcast signals based at least in part on the modification scheme, the instructions are executable by the at least one processor, individually or in any combination, to cause the apparatus to:
process the one or more subsequent broadcast signals before an initial content change boundary, wherein the initial content change boundary is a temporally first initial content change boundary after transmission of the uplink wakeup signal.

6. The apparatus of claim 2, wherein the one or more subsequent broadcast signals comprises a second broadcast signal that is a temporally first broadcast signal broadcasted after transmission of the uplink wakeup signal.

7. The apparatus of claim 2, wherein, to obtain the indication of the modification scheme, the instructions are executable by the at least one processor, individually or in any combination, to cause the apparatus to:
receive signaling indicating the modification scheme from the network entity, from a second network entity, or both.

8. The apparatus of claim 2, wherein, to obtain the indication of the modification scheme, the instructions are executable by the at least one processor, individually or in any combination, to cause the apparatus to:
receive a radio resource control message or a system information block indicating the modification scheme.

9. The apparatus of claim 2, wherein the modification scheme is common for communications via a set of frequencies, for cells within a group, or both.

10. The apparatus of claim 1, wherein the instructions are further executable by the at least one processor, individually or in any combination, to cause the apparatus to:
establish a link with the network entity based at least in part on transmitting the uplink wakeup signal;
receive signaling indicating a content change in at least a portion of the broadcast signal; and
process one or more subsequent broadcast signals based at least in part on the signaling indicating the content change.

11. The apparatus of claim 10, wherein, to receive the signaling indicating the content change, the instructions are executable by the at least one processor, individually or in any combination, to cause the apparatus to:
receive information associated with one or more versions of the broadcast signal.

12. The apparatus of claim 11, wherein, to process the one or more subsequent broadcast signals, the instructions are executable by the at least one processor, individually or in any combination, to cause the apparatus to:
configure one or more receive beam parameters based at least in part on determining whether a correlation between a subsequent broadcast signal of the one or more subsequent broadcast signals and a version of the one or more versions of the broadcast signal satisfies a correlation threshold.

13. The apparatus of claim 10, wherein, to receive the signaling indicating the content change, the instructions are executable by the at least one processor, individually or in any combination, to cause the apparatus to:
receive a physical downlink control channel transmission or a physical downlink shared channel transmission indicating the content change in at least the portion of the broadcast signal based at least in part on establishing the link with the network entity.

14. The apparatus of claim 1, wherein the instructions are further executable by the at least one processor, individually or in any combination, to cause the apparatus to:
transmit a request for information associated with a modification scheme for at least a portion of the broadcast signal, a request for information associated with a content change in at least the portion of the broadcast signal, or both.

15. The apparatus of claim 1, wherein the broadcast signal comprises a bitmap that indicates the at least one additional parameter, and wherein the at least one additional parameter indicates a preamble type, a sequence length, a transmission time, or any combination thereof, associated with the uplink wakeup signal.

16. The apparatus of claim 1, wherein the one or more fixed parameters comprise a preamble associated with the uplink wakeup signal, a quantity of synchronization signal blocks per wakeup signal occasion, a root sequence index associated with the uplink wakeup signal, a subcarrier spacing associated with the uplink wakeup signal, a frequency division multiplexing parameter associated with the uplink wakeup signal, a frequency domain location associated with the uplink wakeup signal, a target power level associated with the uplink wakeup signal, a threshold quantity of transmission attempts of the uplink wakeup signal, or any combination thereof.

17. The apparatus of claim 16, wherein, to obtain the one or more fixed parameters, the instructions are further executable by the at least one processor, individually or in any combination, to cause the apparatus to:
receive control signaling indicating the one or more fixed parameters.

18. An apparatus for wireless communication at a network entity, comprising:
at least one processor; and
at least one memory coupled with the at least one processor, with instructions stored in the at least one memory, the instructions being executable by the at least one processor, individually or in any combination, to cause the apparatus to:
output a broadcast signal indicating at least one additional parameter associated with a configuration for an uplink wakeup signal, the at least one additional parameter being different from one or more fixed parameters associated with the configuration for the uplink wakeup signal, wherein one or more wakeup signal occasions associated with the configuration for the uplink wakeup signal are separate from one or more random access occasions associated with a random access procedure; and
obtain, for a user equipment (UE) the uplink wakeup signal during a wakeup signal occasion of the one or more wakeup signal occasions based at least in part on the one or more fixed parameters and on the at least one additional parameter.

19. The network entity of claim 18, wherein the instructions are further executable by the at least one processor, individually or in any combination, to cause the apparatus to:
output an indication of a modification scheme associated with a content change for at least a portion of the broadcast signal; and
output one or more subsequent broadcast signals based at least in part on the modification scheme.

20. The network entity of claim 19, wherein the modification scheme indicates a modification periodicity of an initial content change boundary.

21. The network entity of claim 19, wherein, to output the one or more subsequent broadcast signals based at least in part on the modification scheme, the instructions are executable by the at least one processor, individually or in any combination, to cause the apparatus to:
perform a content change of at least a portion of the one or more subsequent broadcast signals after an initial content change boundary that occurs after the uplink wakeup signal is obtained.

22. The network entity of claim 19, wherein, to output the one or more subsequent broadcast signals based at least in part on the modification scheme, the instructions are executable by the at least one processor, individually or in any combination, to cause the apparatus to:
perform a content change of at least a portion of the one or more subsequent broadcast signals before an initial content change boundary, wherein the initial content change boundary is a temporally first initial content change boundary after the uplink wakeup signal is obtained.

23. The network entity of claim 19, wherein, to output the one or more subsequent broadcast signals based at least in part on the modification scheme, the instructions are executable by the at least one processor, individually or in any combination, to cause the apparatus to:
perform a content change of at least a portion of a second broadcast signal that is a temporally first broadcast signal broadcasted after the uplink wakeup signal is obtained.

24. The network entity of claim 19, wherein, to output the indication of the modification scheme, the instructions are executable by the at least one processor, individually or in any combination, to cause the apparatus to:
output a radio resource control message or a system information block indicating the modification scheme.

25. The network entity of claim 19, wherein the modification scheme is common for communications via a set of frequencies, for cells within a group, or both.

26. The network entity of claim 18, wherein the instructions are further executable by the at least one processor, individually or in any combination, to cause the apparatus to:
establish a link with the UE based at least in part on the uplink wakeup signal;
output signaling indicating a content change in at least a portion of the broadcast signal; and
output one or more subsequent broadcast signals based at least in part on the content change.

27. The network entity of claim 26, wherein, to output the signaling indicating the content change, the instructions are executable by the at least one processor, individually or in any combination, to cause the apparatus to:
output information associated with one or more versions of the broadcast signal.

28. The network entity of claim 26, wherein, to output the signaling indicating the content change, the instructions are executable by the at least one processor, individually or in any combination, to cause the apparatus to:
output a physical downlink control channel transmission or a physical downlink shared channel transmission indicating the content change in at least the portion of the broadcast signal based at least in part on establishing the link with the UE.

29. A method for wireless communication at a user equipment (UE), comprising:
obtaining one or more fixed parameters associated with a configuration for an uplink wakeup signal associated with the UE;
receiving, from a network entity, a broadcast signal indicating at least one additional parameter associated with the configuration for the uplink wakeup signal, the at least one additional parameter being different from the one or more fixed parameters, wherein one or more wakeup signal occasions associated with the configuration for the uplink wakeup signal are separate from one or more random access occasions associated with a random access procedure; and
transmitting the uplink wakeup signal during a wakeup signal occasion of the one or more wakeup signal occasions based at least in part on the one or more fixed parameters and on the at least one additional parameter.

30. A method for wireless communication at a network entity, comprising:
outputting a broadcast signal indicating at least one additional parameter associated with a configuration for an uplink wakeup signal, the at least one additional parameter being different from one or more fixed parameters associated with the configuration for the uplink wakeup signal, wherein one or more wakeup signal occasions associated with the configuration for the uplink wakeup signal are separate from one or more random access occasions associated with a random access procedure; and
obtaining, for a user equipment (UE) the uplink wakeup signal during a wakeup signal occasion of the one or more wakeup signal occasions based at least in part on the one or more fixed parameters and on the at least one additional parameter.
